(19) United States
(12) Patent Application Publication
(10) Pub. No.: US 2026/0191228 A1
(43) Pub. Date: Jul. 9, 2026

(54) ANIMAL FEED COMPOSITION AND METHOD FOR MANUFACTURE THEREOF

(71) Applicants: Richard Clegg, Bristol (GB); SAXO-SIAM PTE. LTD., Singapore (SG)

(72) Inventor: Felix Collins, Singapore (SG)

(21) Appl. No.: 19/130,494

(22) PCT Filed: Nov. 29, 2023
(86) PCT No.: PCT/EP2023/083520

§ 371 Date: May 15, 2025

(30) Foreign Application Priority Data
Nov. 29, 2022 (GB) 2217899.0

(51) Int. Cl. A23K 10/12; A23K 10/14; A23K 10/16; A23K 10/26; A23K 10/30; A23K 20/163; A23K 30/00; A23K 40/10; A23K 50/80

(52) U.S. Cl. CPC A23K 10/12; A23K 10/14; A23K 10/16; A23K 10/26; A23K 10/30; A23K 20/163; A23K 30/00; A23K 40/10; A23K 50/80

(57) ABSTRACT

Provided herein is a composition for animal feed comprising a fermented organic material, black soldier fly biomass, fermented black soldier fly frass and microbial biomass. Methods of producing the composition are also provided. The composition can be produced from food waste, and provides an environmentally-friendly alternative to existing protein sources for farmed animals, particularly fishmeal.

### FIELD

The present invention relates to a composition for animal feed based on a fermented organic material, and a method for degrading organic material which can be used to manufacture the composition for animal feed.

### BACKGROUND

The global animal feed business is worth around $400 billion per year, and produces one twentieth of the world's greenhouse gas emissions. The primary protein source in many animal feeds is fishmeal, which is made by cooking, pressing, drying and grinding of whole fish into fishmeal powder. Fishmeal is used to feed a wide range of farmed animals, including pigs, poultry and fish.

However, the use of fishmeal in animal feed is controversial as the high global demand for fishmeal has led to overfishing (particularly around developing countries), resulting in the collapse of fisheries and damage to ecosystems. A combination of increased demand for animal feed and fishery loss caused by overfishing is predicted to cause the price of fishmeal to almost double by 2030, meaning alternative protein sources are sought.

One alternative protein source is soybean, which is already commonly used in animal feed. However, global soybean production is insufficient to substitute for fishmeal, and soybean production is also associated with environmental damage, particularly deforestation for land for soybean cultivation.

The attention of the animal feed industry has recently turned to insects as an animal feed ingredient. Insects have high nutritional value and are easy and cheap to rear, and their use is neither environmentally nor ethically controversial. An insect of particular interest in the animal feed industry is black soldier fly (BSF). BSF larvae have a protein content of over 40% and so have great potential to replace fishmeal in animal feed. The larvae have straightforward requirements for survival and growth, such that they can be reared on organic waste such as food waste or even animal manure. As a result, BSF larvae are commonly used as a fish food in small fish farms, whereby the larvae are reared and fed directly to fish (Astuti & Wiryawan, Animal Bioscience 35(2): 356-363, 2022). BSF larvae meal has also been used in feed for livestock, for instance in goat farming, where a BSF larvae meal milk replacer has been successfully used to feed kids prior to weaning and BSF larvae meal-based feed has been used successfully in rearing kids post-weaning (Astuti & Wiryawan, supra).

BSF frass is also of interest as an animal food ingredient, particularly in aquaculture. Frass is a by-product of larval growth, comprising larval waste, shedded exoskeletons and dead larvae, which contains around 20% protein in addition to other essential nutrients. The inclusion of BSF frass in fish food was found to have a positive impact on growth of herbivore and detritivore fish species, but to be unsuitable as feed for carnivorous fish (Banavar et al., Animals 12: 2407, 2022).

Another environmental challenge facing the world today is that of food waste. The Food and Agriculture Organisation of the United Nations has estimated that approximately one third of the products intended for human consumption is wasted or lost every year. In developing countries, the losses are primarily in the first steps of the food supply chain, during harvest and processing. In developed countries, food is additionally discarded by retailers and consumers. Many challenges are associated with reducing food waste, and some wastage is unavoidable, particularly in food processing. Accordingly, attention has shifted to food waste valorisation. Fermentation and anaerobic digestion of food waste to produce energy in the form of biogas and biofuel has become commonplace. The use of microorganisms to produce biomaterials such as bioplastics from food waste has also arisen.

More recently, food waste has been identified as a potential source of higher value chemicals suitable for use as e.g. flavourings or aromas. For instance, agricultural wastes such as sugar beet pulp and cereal bran have been identified as sources of ferulic acid, which can be biotransformed by natural or engineered microorganisms into vanillin, the component of vanilla responsible for its flavour/aroma (Saadoun et al., Foods 10: 707, 2021).

### SUMMARY OF INVENTION

The present invention provides a new composition suitable for use as an animal feed, along with a method by which such an animal feed can be made. The feed composition is obtained by processing organic material, such as food waste, with BSF larvae and a microbial cocktail, which are also included in the end product. The invention thus addresses two pressing environmental challenges (food waste and the use of unsustainable animal feed components) to yield a nutritious and affordable animal feedstuff with a minimal environmental footprint. The combination of both microbial and entomological processing of organic material to yield the animal feed composition of the invention is unique and highly advantageous.

In a first aspect, the invention provides a composition for animal feed comprising a fermented organic material, black soldier fly biomass, fermented black soldier fly frass and microbial biomass. In some embodiments, the composition comprises about 5 to 25% w/w black soldier fly biomass and about 0.05 to 5% w/w microbial biomass.

In a second aspect, the invention provides a method for degrading organic material, the method comprising contacting the organic material with black soldier fly larvae and a microbial composition comprising at least one microbe capable of fermenting the organic material, and incubating the organic material with the black soldier fly larvae and the microbial composition such that the organic material is processed by the black soldier fly larvae and the at least one microbe;
wherein the method yields a product composition comprising fermented organic material, black soldier fly larvae biomass and microbial biomass.

In embodiments, the microbial composition comprises:
(i) at least one digestive microbe, wherein the digestive microbe produces a digestive enzyme;
(ii) at least one protein-enhancing microbe, wherein the protein-enhancing microbe increases the protein content of the product composition; and/or
(iii) at least one microbe that increases the nutritive value and/or health value of the product composition, and/or reduces the environmental impact of the method. fermenting the organic material.

In a third aspect, the invention provides the use of black soldier fly larvae and a microbial composition as defined in the second aspect for degrading organic material, thereby to yield a product composition.

In a fourth aspect, the invention provides a product composition obtainable from a method as defined in the second aspect.

In a fifth aspect, the invention provides a composition for degrading organic material, the composition comprising black soldier fly larvae and a microbial composition as defined in the second aspect.

In a sixth aspect, the invention provides a kit for degrading organic material, the kit comprising black soldier fly larvae and a microbial composition as defined in the second aspect.

### DESCRIPTION OF INVENTION

The present invention relates to a composition for animal feed (that is to say a composition suitable for use as an animal feed, or a composition suitable to be fed to animals) and methods by which the composition may be made.

### Compositions

The composition for animal feed may alternatively and interchangeably be referred to herein as an animal feed composition. The composition is obtainable by a method comprising contacting an organic material with BSF larvae and a microbial composition (or cocktail) and incubating the organic material with the BSF larvae and microbial composition such that the organic material is processed by the BSF larvae and the microbes contained within the microbial composition, as detailed below. Processing of the organic material includes both consumption and digestion of the organic material by the BSF larvae and fermentation of the organic material by the microbes of the microbial cocktail. Further processing steps may also be performed to obtain the animal feed composition of the invention.

The animal feed composition thus comprises a fermented organic material, black soldier fly biomass, fermented frass (generally fermented black soldier fly frass) and microbial biomass. The animal feed composition according to the present invention may be used as or in feed for any animal. That is to say, the animal feed composition may be used as a standalone animal feed, or as a component of an animal feed which also comprises other components, or as a supplement to an existing animal feed. Any existing animal feed in the art may be supplemented with the animal feed composition of the invention, and standard animal feed components which may be mixed with the animal feed composition of the invention thereby to yield an animal feed are also well known in the art.

The animal feed composition is particularly suitable for consumption by farmed animals, including mammals, birds, fish and crustaceans. For instance, the animal feed composition may be used for feeding livestock, such as cattle, sheep, goats or horses. Similarly, the animal feed composition may be used to feed poultry, such as chickens, turkeys, geese or ducks. Most preferably the animal feed composition is used in aquaculture, i.e. the farming of seafood species. The animal feed composition may be fed to farmed fish and crustaceans, and indeed any type of farmed aquatic species (either saltwater or freshwater). The animal feed composition of the invention can contain a high level of protein, and so may be particular suitable as a feedstuff for carnivorous and omnivorous aquatic species, such as salmon (most commonly Atlantic salmon, Salmo salar, which is farmed in and around the North and South Atlantic ocean) and prawns, including whiteleg shrimp (Litopenaeus vannamei, also known as king prawn), which is farmed around the world, particularly in Latin America, India and Southeast Asia (e.g. Thailand and Indonesia) and tiger prawn (Penaeus monodon) which is farmed around the world. The animal feed composition of the invention is also suitable as a feedstuff for other species (including herbivorous aquatic species), including important farmed species such as carp, tilapia, catfish, crayfish and crab.

The animal feed composition of the invention comprises a fermented organic material. Any organic material may be fermented and used in the composition of the invention, but most commonly the organic material is food waste. By food waste is meant any organic waste product or byproduct of the food industry, including agricultural or farm waste, waste from food processing (e.g. from factories, mills etc.) commercial food waste (e.g. from restaurants, hotels, supermarkets/shops, etc.) and household food waste. The food waste may be plant-based food waste, animal-based food waste or a mixture thereof. The food waste may be of a single type or a mixture of types of food. The food waste may be from cooked or uncooked food.

In preferred embodiments the food waste is non-fibrous, as black soldier fly larvae feed better on non-fibrous foods than fibrous ones. By “fibrous” food here is meant foodstuffs containing high amounts of cellulose fibres, e.g. vegetables. Examples of suitable food waste products which can be used as a base for the animal feed composition of the invention include abattoir waste (e.g. from chicken slaughter), waste from flour manufacture (e.g. cassava pulp from cassava flour production), nut waste from nut milk production, palm oil decanter cake from palm oil production and spent grain (i.e. brewers spent grain (BSG) or draff) and other brewery waste streams. Generally, the skilled person will use a type of food waste which is readily available in their own locality. Moreover, while the animal feed compositions of the invention are suitable to be fed to any animal, as set out above, the skilled person can readily optimise the composition for a particular species of interest by selecting a base material (e.g. food waste type) with a nutrient content appropriate for the nutritional needs of the animal, e.g. a composition intended for an animal with a high dietary protein requirement may be made using a high protein starting material (e.g. food waste).

While food waste may be most commonly used as the base material for the composition of the invention due to e.g. ready availability and low cost, any organic material may be used. Herein, the term “organic material” is used to refer to plant and animal products. Other suitable sources of the organic material, in addition to food waste, include horticultural waste, forestry waste, gardening waste, and waste from other industries which process organic products for non-food manufacturing purposes, e.g. waste from paper manufacture, cosmetics, etc. The organic material which is processed to yield the composition of the invention may be referred to as the base material, the organic base material, the base organic material, the substrate, the organic substrate, etc., all of which terms are used interchangeably herein.

In some embodiments the organic material comprises feathers. Any type or size of feather, from any species of bird, may be used. In such embodiments, the composition of the invention may comprise fermented feathers or feather fragments.

To produce the composition of the invention, the organic substrate is contacted with and incubated with a microbial composition and BSF larvae, such that the organic substrate is processed by the BSF larvae and microbial composition. As noted above, this processing comprises both consumption and digestion of the substrate by BSF larvae and fermentation of the substrate by the microbial composition (i.e. by the microbes within the microbial composition). The incubation process is described in more detail below. Fermentation, as defined herein, may be performed under anaerobic conditions or aerobic conditions. Fermentation is defined herein simply as processing of the organic substrate by a microbial process (i.e. by the microbes of the microbial composition). A strict biochemical definition of the term (anaerobic metabolism of an organic molecule) is not intended.

Thus, in the animal feed composition of the invention, the organic material is (i.e. has been) fermented. A fermented organic material is defined herein as a material which has been subjected to fermentation by one or more microorganisms (the terms “microorganism”, “microbial species” and “microbe” are used interchangeably herein). That is to say, a fermented organic material is defined as having been subjected to processing by one or more microorganism, such that the structure or chemical make-up of the material is changed relative to prior to the microbial processing, at least in part. For instance, the fermented organic material may have been at least partly degraded, digested or metabolised by the one or more microorganism. Fermentation of the organic material may result in the breakdown of carbohydrates (particularly sugars) and the production of chemicals such as lactic acid, lysine and other products of fermentation, which may be present in the fermented organic material in the animal feed composition.

As noted above, the organic material is also contacted with BSF larvae, which feed on (or “process”) the organic material concurrently with its fermentation by the microbial species applied in the microbial composition. The fermented organic material of the composition of the invention is thus a material which has been subjected to biological processing by both microbes and BSF larvae. As mentioned above, the BSF larvae consume and digest the organic substrate, by which is meant that at least part of the organic substrate is consumed and digested during processing of the organic substrate, and this is reflected in the animal feed composition of the invention.

Black soldier fly (Hermetia illucens) is an insect species commonly found across the world. As a species endemic worldwide, it can be used in essentially any country without concern as it is not considered an invasive species. BSF larvae are hatched from BSF eggs. BSF eggs are laid by adult female black soldier flies, and hatch after about 4 days. BSF larvae are about 1 mm long when hatched, but can grow up to about 25 mm long during the larval stage (which lasts about 3-5 weeks, depending on the available food). Thereafter the larvae become pupae and then hatch into adult flies.

The animal feed composition of the invention comprises black soldier fly (BSF) biomass. By “BSF biomass” is essentially meant, in the context of the invention, black soldier fly larvae. The BSF biomass is thus made up of BSF larvae, and may further comprise BSF eggs and/or BSF pupae. Generally the BSF biomass comprises dead BSF larvae, and when it comprises BSF eggs and/or pupae, these are preferably non-viable eggs and/or pupae (i.e. eggs and/or pupae which cannot hatch). It is not excluded that the BSF biomass comprises adult BSF (particularly dead adult BSF), though this is not generally the case. When the BSF biomass comprises dead BSF larvae, they may be killed by any suitable means, bearing in mind that the BSF biomass is a constituent part of a composition to be fed to animals (i.e. a toxic chemical cannot be used).

The animal feed composition of the invention may comprise any amount of BSF biomass, but in particular embodiments comprises about 5-25% w/w BSF biomass, e.g. 5-22, 5-20, 5-18 or 5-15%, 8-25, 8-22, 8-20, 8-18 or 8-15%, 10-25, 10-22, 10-20, 10-18 or 10-15%, 12-25, 12-22, 12-20, 12-18 or 12-15% w/w BSF biomass. In preferred embodiments, the composition comprises 10-20% or 12-18% w/w BSF biomass. In particular embodiments, the composition comprises about 5, 10, 15, 20 or 25% w/w BSF biomass. BSF biomass may be identified as comprising, for example, BSF DNA or RNA or BSF proteins.

The animal feed composition of the invention further comprises fermented BSF frass. As noted above, frass is a by-product of larval growth, comprising larval waste (e.g. larval excretions), shedded exoskeletons and dead larvae. Processing of the base organic material by BSF larvae results in production and deposition of frass in and upon the base material. The frass is thus fermented by the microbes applied to the base material, at the same time as the base material is fermented.

The animal feed composition also comprises microbial biomass. Microbial biomass is biomass (i.e. biological matter) composed of microorganisms. The microbial biomass may comprise any microorganisms. The microorganisms may be alive or dead, though preferably are dead. The microbial biomass may include bacteria, archaea, fungi and/or protists. In particular embodiments the microbial biomass includes bacteria. In particular embodiments the microbial biomass includes fungi. Preferably the microbial biomass comprises bacteria and fungi (i.e. bacterial biomass and fungal biomass).

When the microbial biomass comprises bacterial biomass, the bacterial biomass comprises vegetative cells, and may further comprise endospores, depending on the species present.

In particular embodiments, the microbial biomass does not comprise any pathogenic microbial species. In other embodiments, the microbial biomass does comprise pathogenic microbial species. Preferably, the microbial biomass does not comprise any live pathogenic microorganisms, and preferably the microbial biomass does not comprise any pathogenic spore-forming bacteria. In certain embodiments, the microbial biomass does not comprise antibiotic-resistant strains of bacterial species (that is to say, strains of bacterial species carrying genes which render them resistant to antibiotics to which the species is/was natively susceptible. For instance, vancomycin-resistant Enterococci are antibiotic-resistant strains of Enterococcal species, such as E. faecalis and E. faecium). Equivalently, in certain embodiments the microbial biomass does not comprise fungal strains which are resistant to anti-fungal agents. The microbial biomass comprises microbes applied to the base organic material for fermentation purposes, and all other microbes present in the composition, including the gut microbiota of the BSF larvae and microbes present in the base organic material prior to application of the BSF larvae and microbial composition.

The animal feed composition of the invention may comprise any amount of microbial biomass, but in particular embodiments comprises about 0.05-5% w/w microbial biomass. For example, the composition may comprise about 0.05-4, 0.05-3, 0.05-2, 0.05-1, 0.05-0.9, 0.05-0.8, 0.05-0.7, 0.05-0.6, 0.05-0.5, 0.05-0.4, 0.05-0.3, 0.05-0.2 or 0.05-0.1%, 0.06-5, 0.06-4, 0.06-3, 0.06-2, 0.06-1, 0.06-0.9, 0.06-0.8, 0.06-0.7, 0.06-0.6, 0.06-0.5, 0.06-0.4, 0.06-0.3, 0.06-0.2 or 0.06-0.1%, 0.07-5, 0.07-4, 0.07-3, 0.07-2, 0.07-1, 0.07-0.9, 0.07-0.8, 0.07-0.7, 0.07-0.6, 0.07-0.5, 0.07-0.4, 0.07-0.3, 0.07-0.2 or 0.07-0.1%, 0.08-5, 0.08-4, 0.08-3, 0.08-2, 0.08-1, 0.08-0.9, 0.08-0.8, 0.08-0.7, 0.08-0.6, 0.08-0.5, 0.08-0.4, 0.08-0.3, 0.08-0.2 or 0.08-0.1%, 0.09-5, 0.09-4, 0.09-3, 0.09-2, 0.09-1, 0.09-0.9, 0.09-0.8, 0.09-0.7, 0.09-0.6, 0.09-0.5, 0.09-0.4, 0.09-0.3, 0.09-0.2 or 0.09-0.1%, 0.1-5, 0.1-4, 0.1-3, 0.1-2, 0.1-1, 0.1-0.9, 0.1-0.8, 0.1-0.7, 0.1-0.6 or 0.1-0.5%, 0.2-5, 0.2-4, 0.2-3, 0.2-2, 0.2-1, 0.2-0.9, 0.2-0.8, 0.2-0.7, 0.2-0.6 or 0.2-0.5%, 0.3-5, 0.3-4, 0.3-3, 0.3-2, 0.3-1, 0.3-0.9, 0.3-0.8, 0.3-0.7, 0.3-0.6 or 0.3-0.5%, 0.4-5, 0.4-4, 0.4-3, 0.4-2, 0.4-1, 0.4-0.9, 0.4-0.8, 0.4-0.7, 0.4-0.6 or 0.4-0.5%, 0.5-5, 0.5-4, 0.5-3, 0.5-2, 0.5-1, 0.5-0.9, 0.5-0.8, 0.5-0.7 or 0.5-0.6%, 0.6-5, 0.6-4, 0.6-3, 0.6-2, 0.6-1, 0.6-0.9, 0.6-0.8 or 0.6-0.7%, 0.7-5, 0.7-4, 0.7-3, 0.7-2, 0.7-1, 0.7-0.9 or 0.7-0.8%, 0.8-5, 0.8-4, 0.8-3, 0.8-2, 0.8-1 or 0.8-0.9%, 0.9-5, 0.9-4, 0.9-3, 0.9-2 or 0.9-1%, or 1-5, 1-4, 1-3 or 1-2% w/w microbial biomass.

Generally, the microbial biomass comprises at least 2 microbial species, preferably at least 3, 4, 5, 6, 7, 8, 9, 10, 11, 12, 13, 14, 15, 16, 17 or 18 microbial species, or more.

In certain embodiments, the microbial biomass comprises a lactic-acid producing microbe; in certain embodiments, the microbial biomass comprises a nitrogen-fixing microbe; in certain embodiments, the microbial biomass comprises a methanotrophic microbe; in certain embodiments, the microbial biomass comprises a probiotic microbe; in certain embodiments, the microbial biomass comprises a microbe capable of secreting an antimicrobial compound; in certain embodiments, the microbial biomass comprises a microbe capable of producing an antioxidant and/or vitamin; in certain embodiments, the microbial biomass comprises a microbe capable of degrading toxins; in certain embodiments, the microbial biomass comprises a microbe which secretes an amino acid, preferably lysine and/or glutamate. These capabilities are described further below.

The animal feed composition of the invention may, therefore, comprise lactic acid, one or more antimicrobial compounds, one or more antioxidants and/or one or more vitamins.

In particular embodiments, the microbial biomass comprises:
(i) at least one microbe selected from Bacillus licheniformis, Enterococcus faecium, Eubacterium ruminantium, Bacillus megaterium (e.g. Bacillus megaterium var. phosphaticum), Bacillus polymyxa and Streptomyces thermophilus;
(ii) at least one microbe selected from Bacillus subtilis, Saccharomyces cerevisiae, Aspergillus oryzae and Streptomyces thermophilus; and/or
(iii) at least one microbe selected from Bacillus subtilis, Lactobacillus plantarum, Lactobacillus acidophilus, Pediococcus pentosaceus, Aspergillus oryzae, Azotobacter vinelandii, Azospirillum sp., Bacillus megaterium (e.g. Bacillus megaterium var. phosphaticum) and Bacillus polymyxa. In particular embodiments the microbial biomass comprises at least one microbial species from each of (i), (ii) and (iii).

As set out further below, broadly speaking the three lists of species correspond to groups of bacterial species which perform different functions during fermentation of the base material. It will be noted that certain species are recited in more than one of the two lists (e.g. B. subtilis is listed under point (ii) and point (iii)). Thus inclusion of such a species covers both lists, e.g. if the microbial biomass comprises B. subtilis, in these embodiments the microbial biomass would be considered to include a microbial species from each of lists (ii) and (iii).

The microbial biomass of the composition of the invention may alternatively, or additionally, comprise at least one species selected from Corynebacterium glutamicum, Aneurinbacillus danicus, Methylococcus capsulatus and Bacillus firmus.

Thus in a particular embodiment, the microbial biomass comprises:
(i) at least one microbe selected from Bacillus licheniformis, Enterococcus faecium, Eubacterium ruminantium, Bacillus megaterium var. phosphaticum, Bacillus polymyxa and Streptomyces thermophilus;
(ii) at least one microbe selected from Bacillus subtilis, Saccharomyces cerevisiae, Aspergillus oryzae and Streptomyces thermophilus;
(iii) at least one microbe selected from Bacillus subtilis, Lactobacillus plantarum, Lactobacillus acidophilus, Pediococcus pentosaceus, Aspergillus oryzae, Azotobacter vinelandii, Azospirillum sp., Bacillus megaterium var. phosphaticum and Bacillus polymyxa and
(iv) at least one microbe selected from Corynebacterium glutamicum, Aneurinbacillus danicus, Methylococcus capsulatus and Bacillus firmus.

In other embodiments, the microbial biomass comprises at least one microbial species selected from Bacillus licheniformis, Enterococcus faecium, Eubacterium ruminantium, Bacillus megaterium var. phosphaticum, Bacillus polymyxa, Streptomyces thermophilus, Bacillus subtilis, Saccharomyces cerevisiae, Aspergillus oryzae, Lactobacillus plantarum, Lactobacillus acidophilus, Pediococcus pentosaceus, Azotobacter vinelandii Azospirillum sp., Corynebacterium glutamicum, Aneurinbacillus danicus, Methylococcus capsulatus and Bacillus firmus. The microbial biomass may comprise at least 2, 3, 4, 5, 6, 7, 8, 9, 10, 11, 12, 13, 14, 15, 16 or 17 of these species, or may comprise all of these species.

In other embodiments, the microbial biomass comprises at least 4 microbial species selected from Bacillus licheniformis, Enterococcus faecium, Eubacterium ruminantium, Bacillus megaterium var. phosphaticum, Bacillus polymyxa, Streptomyces thermophilus, Bacillus subtilis, Saccharomyces cerevisiae, Aspergillus oryzae, Lactobacillus plantarum, Lactobacillus acidophilus, Pediococcus pentosaceus, Azotobacter vinelandii and Azospirillum sp., preferably at least 5, 6, 7, 8, 9, 10, 11, 12 or 13 of these species, or may comprise all these species. This may include at least 1 species from list (i) above, at least 1 species from list (ii) above, and at least 1 species from list (iii) above.

In other embodiments, the microbial biomass comprises at least 5 microbial species selected from Bacillus licheniformis, Enterococcus faecium, Eubacterium ruminantium, Bacillus megaterium var. phosphaticum, Bacillus polymyxa, Streptomyces thermophilus, Bacillus subtilis, Saccharomyces cerevisiae, Aspergillus oryzae, Lactobacillus plantarum, Lactobacillus acidophilus, Pediococcus pentosaceus, Azotobacter vinelandii, Azospirillum sp., Corynebacterium glutamicum, Aneurinbacillus danicus, Methylococcus capsulatus and Bacillus firmus, including at least 1 species from list (i) above, at least 1 species from list (ii) above, at least 1 species from list (iii) above and at least 1 species from list (iv) above.

In preferred embodiments the microbial biomass comprises B. subtilis.

The species contained within the microbial biomass may be most readily identified by their DNA or RNA sequences. Routinely, microbial species may be identified by rRNA sequencing (in particular, bacterial species can be identified by their 16S rRNA sequences and fungal species by their 18S rRNA sequences). The skilled person is readily able to determine the microbial species present in a particular composition of interest.

The above species may be obtained from a cell bank or depositary, e.g. the ATCC. For instance, strains of B. licheniformis are available from the ATCC under accession numbers 14580 and 9789, inter alia; strains of E. faecium are available from the ATCC under accession numbers BAA-2317 and BAA-2127, inter alia; E. ruminantium is available from the ATCC under accession number 17233; Bacillus megaterium var. phosphaticum is available from the DSMZ under accession number DSM-3228; Bacillus polymyxa (also known as Paenibacillus polymyxa) is available from the ATCC under accession numbers 842 and 7070, inter alia; Streptomyces thermophilus is available from the ATCC under accession number 19282; Bacillus subtilis is available from the ATCC under accession numbers 6051 and 21332, inter alia; Saccharomyces cerevisiae is available from the ATCC under accession numbers 9763 and 834, inter alia; Aspergillus oryzae is available from the ATCC under accession numbers 1011 and 42149, inter alia; Lactobacillus plantarum is available from the ATCC under accession numbers 8014 and 14917, inter alia; Lactobacillus acidophilus is available from the ATCC under accession numbers 4356 and 314, inter alia; Pediococcus pentosaceus is available from the ATCC under accession numbers 33316 and 25745, inter alia; Azotobacter vinelandii is available from the ATCC under accession numbers 9046 and 478, inter alia; Azospirillum sp. are available from the ATCC under accession numbers 29145 and 29708, inter alia; Corynebacterium glutamicum is available from the ATCC under accession numbers 13032 and 14067, inter alia; Aneurinbacillus danicus is available from the DSMZ under the accession number DSM 21566; Methylococcus capsulatus is available from the ATCC under accession numbers 33009 and 19069; and Bacillus firmus is available from the ATCC under accession numbers 14575 and 8247.

The animal feed composition of the invention may be dry, i.e. it may have a low water content or liquid content. In particular embodiments, the animal feed composition has a water content of about 15% (v/v) or less, e.g. about 14, 13, 12, 11, 10, 9, 8, 7, 6 or 5% v/v or less. Preferably the water content is about 10% (v/v) or less. A low water content may be achieved by heating the composition, as described further below.

The animal feed composition may be crushed, ground or blended, to disrupt and break up the fermented organic material. Crushing, grinding or blending will also kill and break up the BSF larvae in the composition. These processes render the composition more readily edible, particularly for smaller animals.

When the animal feed composition is dry, it may be powdered (i.e. the animal feed composition may be a powder). A powdered composition is advantageous for shelf life, ease of transport and ease of combining with other ingredients to make an animal feed. For the same reasons, the composition may further comprise a preservative. Suitable preservatives are well known in the art and include e.g. propionic acid, formic acid, lactic acid, citric acid, sorbic acid, acetic acid (and salts of the aforementioned acids such as their sodium, potassium and calcium salts), antioxidants, such as ascorbic acid (vitamin C) and salts thereof, tocopherols (forms of vitamin E), butylated hydroxyanisole (BHA), butylated hydroxytoluene (BHT) and propyl gallate, and anti-fungal agents such as natamycin. Similarly, the composition of the invention may be pelletised, i.e. it may be provided in the form of pellets, which are suitable to feed to animals, as discussed further below.

In particular embodiments, the composition of the invention is free of living organisms. That is to say, the composition is both free of living BSF and also free of living microorganisms. In this case, the BSF larvae (and any BSF adults) in the composition are dead, as are any BSF pupae, and any BSF eggs are non-viable (i.e. cannot hatch BSF larvae). Vegetative bacterial cells are also dead, as are cells of other types of microorganism (e.g. fungal cells), though viable endospores may be present. The composition may preferably be sterile (i.e. in which case in addition to being free of living organisms, the composition also does not contain viable endospores).

In other preferred embodiments, the composition of the invention comprises endospores of a sporulating bacterium (or bacteria), particularly a probiotic bacterium (or bacteria), such as B. subtilis, B. licheniformis, B. megaterium or B. polymyxa. Preferably, the composition comprises B. subtilis endospores.

The animal feed composition of the invention is a nutritious composition and generally comprises high levels of protein, in addition to carbohydrate and fat, to support animal growth. The amount of each type of macronutrient will depend on the base material used for fermentation and the desired composition for the animal to be fed. For instance, on a dry matter basis, the animal feed composition may comprise at least 15, 20, 25, 30, 35 or 40% (w/w) protein. In some embodiments it is preferred that the composition comprises at least 40% protein, e.g. at least 45 or 50% protein. The animal feed composition may comprise, on a dry matter basis, at least 15, 20, 25, 30, 35 or 40% (w/w) carbohydrate, and/or at least 3, 5, 10, 15, 20, 25 or 30% (w/w) fat. In some embodiments, the animal feed composition is defatted, and thus comprises a low amount of fat, e.g. about 3-5%.

In some embodiments, the animal feed composition comprises at least 20% protein, at least 20% carbohydrate and at least 20% fat (all w/w on a dry matter basis). In some embodiments, the animal feed composition comprises at least 25% protein, at least 25%, 30% or 35% carbohydrate, and, optionally, at least 20% fat (all w/w on a dry matter basis). In some embodiments the composition comprises at least 50% protein and at least 30% fat (all w/w on a dry matter basis).

When the composition is defatted, it may comprise at least 30% protein and at least 30%, 35% or 40% carbohydrate. In other embodiments it may comprise at least 50, 55, 60, 65, 70 or 75% protein (all w/w on a dry matter basis).

In some embodiments, the animal feed composition comprises starch. For example, the animal feed composition may comprise resistant starch, i.e. starch that resists digestion into sugars (such as maltose and/or glucose) in the small intestine of animals. Resistant starches may be fermented by the gut microbiota of animals, resulting in the production of short chain fatty acids such as butyrate.

In particular embodiments, the animal feed composition comprises resistant starch type 3 (RS3 starch). RS3 starch may be obtained by, for instance, heating and cooling resistant starch type 2 (RS2 starch) during production of the composition.

The animal feed composition of the invention may comprise postbiotics, i.e. metabolic products of the microbial biomass which provide physiological benefits to animals which eat the composition. Postbiotics which may be included in the composition include lactic acid (e.g. produced by lactic acid bacteria such as Lactobacilli), short-chain fatty acids and surfactin. Short-chain fatty acids (SCFAs) are defined herein as saturated aliphatic organic acids that comprise one to six carbon atoms. SCFAs which may be included in the composition include acetate propionate and butyrate. SCFAs are commonly produced by Firmicutes, such as Lactobacilli. Surfactin is a cyclic lipopeptide antibiotic produced by B. subtilis.

### Methods of Degrading Organic Materials

In a second aspect, the invention provides a method of degrading organic material. As noted above, this method may be used to produce the animal feed composition of the invention, however, the method may be used for any other suitable purpose as desired by the skilled person. For instance, the method may be used to produce fertiliser from organic waste, or simply for waste management purposes.

The organic material degraded according to the present method may be any organic material as defined above with respect to the base material for the animal feed composition. By “degrading” is meant that the organic material is broken down or processed. As detailed further below, the method includes fermenting the organic material, and so the degradation includes fermentation. However, the degradation also includes consumption and digestion of the organic material by BSF larvae. Consumption of the organic material by BSF larvae will reduce the overall mass of the material.

In some embodiments, the organic material may be supplemented with one or more prebiotics prior to or during contacting with the BSF larvae and microbial composition. A ‘prebiotic’ is defined herein as a compound that promotes growth of the species in the microbial composition.

Suitable prebiotics for addition to the organic material include resistant starches, part RS2 starch. RS2 starch is a type of starch which has a structure or conformation which renders it inaccessible to starch-degrading enzymes such as amylase or isoamylase. RS2 starch is generally granular, i.e. added to the organic material in the form of granules. RS2 starch is fermented rapidly and efficiently by the microbial composition, thus improving the speed of the fermentation process.

Any suitable amount of RS2 starch may be added to the organic material, depending on e.g. the origin and content of the organic material and the metabolic needs of the microbial composition. RS2 starch may be added to the organic material to a proportion of about 5-15% w/w, e.g. 5-12%, 5-10%, 6-9% or 7-8% w/w on a dry weight basis. That is to say, RS2 starch may be added to the organic materials such that it constitutes e.g. 5-10, 6-9 or 7-8% w/w of the resulting product on a dry weight basis.

The RS2 starch may be included in the context of purified starch granules. Alternatively, the RS2 starch may be included in the context of a starchy raw material, e.g. uncooked potato or unripe bananas.

The method includes contacting the organic material with BSF larvae and a microbial composition. Contacting of the organic material with the BSF larvae may be achieved either by applying BSF larvae directly to the organic material, or by applying BSF eggs to the organic material, and allowing the eggs to hatch into BSF larvae.

Larvae may be applied to the organic material at any age or size. However, towards the end of the larval stage, BSF larvae enter a post-feeding phase in preparation for pupation. It is generally desirable that the BSF larvae continue feeding on the organic material throughout the degradation process, and therefore that the process should be completed before the larvae enter the post-feeding phase. In general the larval stage lasts up to about 18 days before the post-feeding (or prepupal) stage begins, and so the age of larvae used should be selected based on the length of process desired, with the aim that the degradation process be complete before the post-feeding phase begins.

The degradation (i.e. incubation) process may be of any suitable length as required for sufficient degradation of the substrate. For instance, the degradation process may last about 5-14 days, e.g. 5-12, 5-10, 5-8, 5-7. 6-14, 6-12, 6-10, 6-8, 7-14, 7-12, 7-10, 8-14, 8-12, 8-10, 9-14, 9-12, 9-10, 10-14, 10-12 or 12-14 days, preferably about 6-12, 7-12 or 8-12 days. In preferred embodiments the degradation process lasts about 6, 7, 8, 9, 10, 11 or 12 days. The length of the degradation process may be defined as the length of time for which the organic material is incubated with the BSF larvae and microbial composition. If the BSF larvae and the microbial composition are added at separate times, the length of the degradation process may be counted either from the time the first of the larvae and the microbial composition are applied to the organic material or at the time the second of the larvae and the microbial composition are applied. That is, the length of the degradation process may be defined as the length of time for which the organic material is incubated with both the BSF larvae and the microbial composition, or the length of time for which it is incubated with at least one of them. Preferably the length of the degradation process, as set out above, refers to the length of time for which the substrate is incubated with both the BSF larvae and the microbial composition.

BSF larvae may therefore be applied to the organic material at any age, taking into account the length of the degradation process. In particular embodiments the larvae are applied to the organic material at an age of up to about 12 days, e.g. up to 11, 10, 9, 8, 7, 6, 5, 4, 3 or 2 days. In embodiments, the larvae are applied to the organic material at an age of about 1, 2, 3, 4, 5, 6, 7, 8, 9, 10, 11 or 12 days. In embodiments, the larvae are applied to the organic material at an age of 1-10, 1-9, 1-8, 1-7, 1-6, 1-5, 1-4, 2-10, 2-9, 2-8, 2-7, 2-6, 2-5, 2-4, 3-10, 3-9, 3-8, 3-7, 3-6, 3-5, 4-10, 4-9, 4-8, 4-7, 4-6, 5-10, 5-9, 5-8, 5-7, 6-10, 6-9, 6-8, 7-10, 7-9 or 8-10 days. In preferred embodiments, the larvae are applied to the organic material at an age of 1-5 or 4-6 days, in particular about 5 days.

When larvae are applied directly to the organic material, the larvae may be applied to the material at a weight ratio of at least 1:250 (i.e. 1 g larvae per 250 g organic material), 1:225, 1:200, 1:175, 1:150, 1:125, 1:100, 1:75 or 1:50. Preferably, the larvae are applied to the organic material at a weight ratio of at least 1:150 (i.e. it is preferred that at least 1 g larvae is applied per 150 g organic material), e.g. at least 1:140, 1:130, 1:120, 1:110, 1:100, 1:90, 1:80, 1:70, 1:60 or 1:50. In preferred embodiments the larvae are applied to the organic material at a weight ratio of about 1:250, 1:225, 1:200, 1:175, 1:150, 1:140, 1:130, 1:120, 1:110, 1:100, 1:90, 1:80, 1:70, 1:60 or 1:50. Higher weight ratios may be used, as there is no technical maximum number of larvae that can be used to degrade a given size of organic material (within reason), though above a certain number performance of the individual larvae may become sub-optimal due to competition for food, and use of excessive numbers of larvae may be uneconomical.

As noted above, the organic material may be contacted with the BSF larvae by applying BSF eggs to the organic material, and allowing the eggs to hatch on or in the organic material. BSF eggs take about 4 days to hatch from laying, and thus the total length of the process may need to be extended if BSF eggs are applied to the material, to allow for hatching time. When BSF eggs are applied, they may be applied in the first day after being laid or at any time after that, e.g. 1, 2, 3 or 4 days after they were laid.

1 g of BSF eggs yields about 30,000 larvae (by comparison, at an age of 5 days larvae weigh on average about 0.02 grams, or about 600× the weight of an egg, and thus 1 g of 5 day old larvae corresponds to about 50 larvae). Therefore a very small weight of BSF eggs are needed to yield enough larvae to process the organic material. For instance, a suitable weight ratio of eggs to organic material is in the range 1:5,000 to 1:100,000, e.g. 1:5,000 to 1:90,000; 1:5,000 to 1:80,000; 1:5,000 to 1:70,000; 1:5,000 to 1:60,000; 1:5,000 to 1:50,000; 1:5,000 to 1:40,000; 1:10,000 to 1:100,000; 1:10,000 to 1:90,000; 1:10,000 to 1:80,000; 1:10,000 to 1:70,000; 1:10,000 to 1:60,000; 1:10,000 to 1:50,000; 1:10,000 to 1:40,000; 1:20,000 to 1:100,000; 1:20,000 to 1:90,000; 1:20,000 to 1:80,000; 1:20,000 to 1:70,000; 1:20,000 to 1:60,000; 1:20,000 to 1:50,000; 1:20,000 to 1:40,000; 1:30,000 to 1:100,000; 1:30,000 to 1:90,000, 1:30,000 to 1:80,000; 1:30,000 to 1:70,000; 1:30,000 to 1:60,000; 1:30,000 to 1:50,000; 1:40,000 to 1:90,000; 1:40,000 to 1:80,000; 1:40,000 to 1:70,000; 1:40,000 to 1:60,000; or 1:50,000 to 1:100,000. In preferred embodiments a weight ratio of eggs to organic material of 1:20,000 to 1:40,000 is used, e.g. 1:25,000 to 1:40,000; 1:30,000 to 1:40,000; 1:35,000 to 1:40,000; 1:20,000 to 1:35,000; 1:25,000 to 1:35,000; 1:25,000 to 1:30,000; 1:30,000 to 1:40,000 or 1:35,000 to 1:40,000. In preferred embodiments a weight ratio of eggs to organic material of about 1:20,000, 1:25,000, 1:30,000, 1:35,000 or 1:40,000 is used.

The BSF larvae or eggs may be applied to the organic material by e.g. pouring or placing the larvae/eggs onto the material, or alternatively the organic material may be poured or placed onto the larvae/eggs. The larvae or eggs may be mixed with the organic material or may be deposited on the surface of material and left to process the material (in the case of BSF eggs, to hatch and then process the material).

The microbial composition with which the organic material is contacted is simply a composition comprising at least one microorganism which plays a role in degrading the organic material, and optionally in improving the characteristics of the resultant product composition in respect of its use as e.g. an animal feed composition. The content of the composition is discussed further below.

The microbial composition may be applied to the organic material in the form of a liquid suspension or culture (in e.g. a growth medium or buffer). A liquid microbial composition may be applied to the organic material by e.g. spraying or pouring. Alternatively, the microbial composition may be applied to the organic material as a dry powder (e.g. a freeze-dried or dehydrated powder), which may similarly be sprayed or poured onto the organic material. After application to the organic material the microbial composition may be mixed with the organic material.

The microbial composition and BSF larvae (or eggs) may be applied to the organic material at the same time, or substantially the same time, e.g. sequentially or within e.g. 1, 2, 3, 4, 5 or 6 hours of each other. Alternatively, the microbial composition and the BSF larvae/eggs may be applied to the organic material at separate times, e.g. at least 6, 12, 18, or 24 hours apart, or at least 1, 2 or 3 days apart. In this case the microbial composition may be applied before the BSF larvae or BSF eggs, or the BSF larvae or BSF eggs may be applied before the microbial composition. Generally however the microbial composition and BSF larvae or eggs are applied to the organic material at substantially the same time.

Prior to application of the BSF larvae or eggs, and generally prior to application of the microbial composition as well, the organic material may be processed to make it easier for the BSF larvae and microbes to digest and degrade. In particular, the organic material may be ground, crushed and/or blended prior to application of the BSF larvae or eggs and the microbial composition. Such processing may be performed using e.g. a blender, food processor or shredder.

The microbial composition comprises at least one microbe capable of fermenting the substrate, that is to say at least one microbial species capable of growing on and processing (e.g. digesting, degrading or metabolising the substrate, or a part or component thereof). Generally the microbial composition comprises multiple microbial species.

In embodiments, the microbial composition comprises at least one digestive microbe, at least one protein-enhancing microbe, and.or at least one microbe that increases the nutritive value and/or health value of the product composition, and/or reduces the environmental impact of the method. Preferably the microbial composition comprises at least one microbial species of each of these three functional types. A single microbe may play two or indeed all three of these roles, depending on its characteristics.

A “digestive microbe” as defined herein is a microbe which secretes a digestive enzyme. A digestive enzyme is any enzyme which breaks down a macronutrient or component of an organic material into smaller parts, e.g. it may break down a polymer, multimer or dimer into smaller molecules, e.g. into its monomeric constituents. Examples of digestive enzymes which may be produced by the at least one digestive microbe include proteases (which break down proteins), lipases (which break down lipids, and in particular break down triglycerides into fatty acids and glycerol) and carbohydrases (which break down carbohydrates). Proteases which may be secreted by the one or more digestive microbes include endopeptidases and exopeptidases, and also proteases defined by their mechanism of action including serine proteases, cysteine proteases, threonine proteases, aspartic proteases, glutamic proteases and metalloproteases. Carbohydrases (also referred to as glycosidases) which may be secreted by the one or more digestive microbes include amylases (which break down starch), cellulases (which break down cellulose), hemicellulases (which break down hemicellulose) including xylanase, chitinase (which breaks down chitin), ligninase (which breaks down lignin) lactase, maltase, isomaltase, sucrase, invertase, trehalase, etc.

A digestive microbe for use in the microbial composition of the invention preferably secretes multiple different digestive enzymes (e.g. at least 2, 3, 4, 5, or 6 digestive enzymes) and/or secretes high levels of digestive enzymes, and/or secretes particularly active digestive enzymes, such that the digestive microbe is particularly effective in degrading the organic material.

Preferably, the digestive microbe for use in the microbial composition of the invention secretes at least one (and preferably multiple) digestive enzymes which degrade polymeric molecules into smaller components, e.g. monomers, such as a protease, amylase, cellulase, etc., as set out above. Digestive enzymes which degrade substrates classed as dietary fibres for humans (e.g. cellulose, hemicellulose, chitin, lignin) are particularly useful, since such polymers cannot be readily digested by BSF larvae.

In a preferred embodiment, the at least one digestive microbe secretes a protease and a carbohydrase. That is to say that, between the digestive microbes in the microbial composition, at least one protease and at least one carbohydrase are secreted. The protease and carbohydrase may be secreted by the same microbial species, or by different species (e.g. one digestive microbe may secrete a protease, and a second digestive microbe may secrete a carbohydrase). The at least one digestive microbe may further secrete a lipase (such that the at least one digestive microbe secretes a protease, a lipase and a carbohydrase).

In particular embodiments, the at least one digestive microbe secretes a carbohydrase selected from a cellulase, a hemicellulase (particularly a xylanase) and an amylase. Preferably, the at least one digestive microbe secretes at least two of these enzymes (e.g. a cellulase and hemicellulase, such as xylanase). The at least one digestive microbe may secrete a cellulase, a hemicellulase (such as a xylanase) and an amylase. These one or more carbohydrases may be secreted by the one or more digestive microbes in addition to a protease, and optionally a lipase.

Examples of suitable species for use as a digestive microbe in the microbial composition include Bacillus licheniformis, Enterococcus faecium, Eubacterium ruminantium, Bacillus megaterium var. phosphaticum, Bacillus polymyxa and Streptomyces thermophilus. In embodiments, the at least one digestive microbe is selected from or comprises any one or more of these species.

Other suitable species for use as digestive microbes may be identified by genetic analysis (by identifying microbial species which encode digestive enzymes with signal peptides in their genomes) or routine microbiology/enzymology, testing the ability of species/strains of interest to degrade substrates of interest. Digestive microbes may also be engineered, by e.g. modifying a known microbial strain to express a desired enzyme (e.g. by introducing the gene of interest into the microbe on a plasmid, or inserting the gene of interest into the genome of the microbe by standard techniques such as CRISPR or homologous recombination) or increasing the expression of a natively-encoded enzyme by e.g. replacing the native promoter with a more active promoter.

Instead of or in addition to including one or more digestive microbes in the microbial composition, one or more digestive enzymes (as described above) may be added directly to the organic substrate. In this case the digestive enzymes may be provided in a purified or part-purified form or in the context of a crude culture supernatant or cell lysate.

A “protein-enhancing” microbe as defined herein is a microbe which increases the protein content of the product composition. That is to say, a protein-enhancing microbe is a microorganism which produces a high level of protein (in particular produces more protein that it degrades or causes to be degraded by protease secretion) such that its presence in the microbial composition causes the product composition to comprise a higher amount of protein than it comprises in the absence of the protein-enhancing microbe. Such microbes can be routinely identified empirically, by testing them in the method of the invention alongside a control method in which the microbe of interest is not included in the microbial composition, but which is otherwise identical to the test method. If the test method (including the microbe of interest) yields a higher protein content in the product composition than does the control method, the microbe of interest is a protein-enhancing microbe.

Examples of suitable species for use as a protein-enhancing microbe in the microbial composition include Bacillus subtilis, Saccharomyces cerevisiae, Aspergillus oryzae and Streptomyces thermophilus. In embodiments, the at least one protein-enhancing microbe is selected from or comprises any one or more of these species.

Protein-enhancing microbes may also be engineered by modifying a known microbial species to produce more protein.

The microbial composition may include at least one microbe that increases the nutritive value and/or health value of the product composition, and/or reduces the environmental impact of the method.

As noted above, the present method yields a product composition, which commonly is an animal feed composition in accordance with the first aspect of the invention (i.e. the product composition is commonly an animal feed or an animal feed component, as described in the first aspect of the invention). Since the product composition is generally suitable for feeding to animals, it is advantageous if the nutritive value (i.e. the amount of nutrients) in the composition is increased, e.g. by virtue of the production of vitamins or other micronutrients in the product composition by microbes in the microbial composition.

For an animal feed, it is also advantageous if the health value of the product composition is increased. By “health value” is meant the value of the product composition to the health of an animal which consumes it, beyond its mere nutritive value. Thus increasing the health value of a product composition means that the positive contribution of the product composition to the general health of the animal is increased. As further discussed below, this may be achieved by including in the microbial composition a microbe which secretes e.g. an anti-microbial compound which may protect a consuming animal from infection, or any other health-enhancing mechanism.

As noted above, the method of the invention has a significantly reduced environmental impact compared to existing method of producing animal feed. Nonetheless, the present method has an environmental impact in terms of production of greenhouse gases and suchlike. Negative aspects of the environmental impact of the present method may be negated by including a microbe in the microbial composition which reduces the environmental impact of the method. A microbe which reduces the environmental impact of the method is a microbe which reduces the environmentally damaging effects of the method, e.g. reduces greenhouse gas emissions associated with the method.

In embodiments the microbial composition comprises at least one microbe which increases the nutritive value and health value of the product composition, or at least one microbe which increases the nutritive value of the product composition and reduces the environmental impact of the method, or at least one microbe which increases the health value of the product composition and reduces the environmental impact of the method, or at least one microbe which increases the nutritive value of the product, increases the health value of the product and reduces the environmental impact of the method. In these embodiments the two or three functions may be played by a single microbe which performs all three functions or by multiple microbes which perform one function each.

In some embodiments, a microbe which increases the nutritive value of the product composition is a nitrogen-fixing microbe, in particular a nitrogen-fixing bacterium. A nitrogen-fixing microbe is a microbe which converts atmospheric nitrogen (N₂) into organic nitrogen e.g. ammonia. Nitrogen-fixing microorganisms may be known as diazotrophs. Many diazotrophs which may be used in the present invention are known in the art, including inter alia bacteria of the genera Azotobacter and Azospirillum, such as Azotobacter vinelandii, Azospirillum brasilense, Azospirillum halopraeferens and Azospirillum lipoferum, and Bacillus polymyxa (also now known as Paenibacillus polymyxa). Non-diazotrophic microorganisms may be modified to have nitrogen-fixing activity by causing expression of the nitrogenase enzyme and associated proteins required for cofactor synthesis, as described in Tatemichi et al. (Bioscience, Biotechnology and Biochemistry 85(10): 2209-2216, 2021), e.g. by recombinant DNA technology. Nitrogen fixation increases the amount of organic nitrogen in and associated with the organic material substrate, which can be converted into amino acids and other biologically-important molecules, promoting growth of the microorganisms and BSF larvae processing the organic material and increasing the overall nutritive value of the resulting product composition.

In some embodiments, a microbe which increases the nutritive value of the product composition produces (and preferably secretes) amino acids, preferably a high level of amino acids. Any amino acid may be secreted by such a microbe, though in particular embodiments the microbe produces or secretes lysine and/or glutamate. Other amino acids which may be produced by the microbe include all proteinogenic amino acids. Bacillus megaterium (also known as Priestia megatarium), including B. megaterium var. phosphaticum, is known to produce a high level of glutamate (in the form of poly-γ-glutamic acid) and thus may be used in the method for this purpose. Another known bacterium which may be used for this purpose is Corynebacterium glutamicum, which produces high levels of several amino acids, notably lysine though also glutamate, threonine, isoleucine, valine, serine, arginine, methionine and cysteine. Other microbial species capable of producing high levels of amino acids and which may be used for this purpose in the current method include the bacterium Lactobacillus plantarum (now also known as Lactiplantibacillus plantarum) and the fungus Aspergillus oryzae. Microbes which produce high levels of amino acids increase the amount of amino acids available to other organisms processing the organic material and thus increase overall protein production. Other microorganisms which produce high levels of amino acids are known to the skilled person. Microorganisms may also be genetically modified to increase amino acid production by introducing or increasing expression in the microorganisms of the genes responsible for synthesis of amino acids of interest.

In some embodiments, a microbe which increases the nutritive and/or health value of the product composition produces one or more vitamins and/or antioxidants. Vitamins are essential micronutrients required for metabolic function in animals. Vitamins which may be produced by the microbe for use in the microbial composition include vitamin A (e.g. retinol), vitamin B, including B₁ (thiamine), B₂ (flavin/riboflavin), B₃ (e.g. niacin), B₅ (pantothenic acid), Bₑ(e.g. pyridoxine), B₇ (biotin), B₉ (folic acid) and B₁₂ (cobalamin), vitamin C (ascorbic acid), vitamin D (including D₁ to D₅), vitamin E and vitamin K (including K₁ and K₂).

An antioxidant is a compound which inhibits oxidation and free radical production. Antioxidants prevent spoilage of food (and thus their production increases the life of animal feed compositions produced according to the method of the invention) and also have beneficial health effects for animals which consume them. Some vitamins are antioxidants (vitamins A, C and E). Other chemicals with antioxidant activity are also known.

Many microbial species which produce vitamins and antioxidants are known in the art and may be used in the method of the invention for this purpose, including e.g. Azospirillum species, which are known to produce B group vitamins including thiamine and riboflavin, Bacillus megaterium, which is known to produce vitamin B₁₂, and Azotobacter vinelandii, which is known to produce B group vitamins including niacin, pantothenic acid, riboflavin and biotin. B. subtilis is known to produce vitamin K₂. Other bacterial species may also be modified to produce vitamins by expressing in them the genes required for vitamin biosynthesis, e.g. B. subtilis has been successfully modified to produce B vitamins including vitamins B₁, B₂, B₅, Bₑ and B₇ (Su et al., Microbial Cell Factories 19: 173, 2020). Thus a microbe which produces (and preferably secretes) a vitamin and/or antioxidants may produce one or more vitamins and/or antioxidants. Such a microbe may produce vitamins which are not antioxidants, vitamins which are antioxidants, and/or antioxidants which are not vitamins.

In some embodiments, a microbe which increases the health value of the product composition is a microbe which produces (and preferably secretes) an antimicrobial compound. An antimicrobial compound is defined as any compound which has a negative impact on growth of one or more microbial species. Antimicrobial compounds include antibacterial, antifungal, antiprotist and antiprotozoan agents. A microbial species may produce one or more antimicrobial compounds of one or more different classes (e.g. antibacterial and anti-fungal compounds). An antibacterial agent which is produced by a microbe for use in the microbial composition may be referred to as an antibiotic. The terms “antibacterial agent” and “antibiotic” are used interchangeably herein. Any antibiotic may be produced by the microbe for use in the microbial composition, including well known classes of antibiotics used in medicine such as R-lactam antibiotics (e.g. penicillins, cephalosporins and carbapenems), polymyxins, rifamycins, quinolones, sulfonamides, macrolids, lincosamides, tetracyclines, aminoglycosides, lipopeptides, etc. Antiobiotics as defined herein also include bacteriocins and lantibiotics. Antibiotics may be bacteriostatic or bactericidal.

Many microbial species are known to produce antimicrobial agents (indeed other microbes are a primary source of antimicrobial agents used medically/industrially today). By including such microbes in the microbial composition antimicrobial agents may be included in the product composition, providing protection against microbial infection to animals which consume the product composition. Preferably, the microbial species used in the microbial composition which produces antimicrobial agents does not produce antimicrobial agents used in human medicine, to avoid the animal feed composition promoting microbial resistance to the antimicrobial agents contained therein. For example, B. subtilis may be used for this purpose, since the species is known to produce more than 20 antibiotic compounds, primarily lantibiotics, along with other antibiotics such as surfactin. Other suitable microbial species which may be used for this purpose are known in the art, or may be generated by expression of genes responsible for antimicrobial agent synthesis by e.g. recombinant technology.

In some embodiments, a microbe which increases the health value of the product composition is a microbe which reduces the amount of toxins in the product composition, e.g. which degrades toxins. Toxins may be produced by microorganisms (particularly bacteria and fungi) present in the organic substrate material, including microorganisms applied thereto in the microbial composition and microorganisms which were present in the organic material prior to application of the microbial composition. In particular embodiments, such a microbe is capable of reducing the amount of mycotoxins in the product composition, preferably removing mycotoxins from the product composition. Mycotoxins are toxic metabolites produced by fungi which include e.g. aflatoxin, ochratoxin, zearalenone and tricothecenes. Certain bacterial species are known to have activity in mycotoxin degradation and may be used for this purpose in the method of the invention, including notably Lactobacillus acidophilus which has been shown to be capable of degradation of zearalenone and tricothecenes in particular (and to a lesser extent aflatoxin and ochratoxin, see Ragoubi et al., Toxins 13(3): 185 (2021)).

In some embodiments, a microbe which increases the nutritive and/or health value of the product composition is a lactic acid-producing microbe. Many microorganisms are capable of producing lactic acid (e.g. during anaerobic respiration), but preferably the lactic acid-producing microbe of the microbial composition is a lactic acid bacterium, i.e. a bacterium which produces lactic acid as its primary end product of carbohydrate metabolism. Lactic acid bacteria are well known in the art, and in particular include bacteria of the genera Lactobacillus, Leuconostoc, Pediococcus, Lactococcus and Streptococcus. Any such lactic acid bacterium may be used. Preferred lactic acid bacteria for use in the microbial composition include Lactobacillus plantarum, Lactobacillus acidophilus and Pediococcus pentosaceus.

The inclusion of lactic acid bacteria (or other lactic acid-producing microbes) in the microbial composition is advantageous as this results in the presence of lactic acid in the product composition. Lactic acid is a preservative and thus acts to reduce spoilage or contamination of the product composition, which reduces the likelihood of food poisoning resulting from the composition. Lactic acid may also act as an antioxidant, improve gut health and boost absorption of other nutrients in the composition.

In some embodiments, a microbe which reduces the environmental impact of the method of the invention is a methanotrophic microbe. Fermentation of the organic material in the method of the invention causes methane production. Methane is a potent greenhouse gas which has a stronger warming effect on the planet than CO₂. Methanotrophic microbes are microbes (generally bacteria or archaea) which are able to metabolise methane (generally into formaldehyde and/or CO₂), reducing the environmental impact of the method. Any methanotrophic microbe may be used in the microbial composition, including e.g. Methylococcus capsulatus, Aneurinbacillus danicus and Bacillus firmus. Other suitable microbial species which may be used for this purpose are known in the art, or may be generated by expression of genes responsible for methane metabolism by e.g. recombinant technology.

Thus in some embodiments, the microbial composition comprises:
(a) a microbe that secretes an antimicrobial compound;
(b) a microbe that degrades toxins;
(c) a lactic acid-producing microbe;
(d) a microbe that produces an antioxidant and/or a vitamin;
(e) a microbe that secretes an amino acid, preferably lysine and/or glutamate;
(f) a nitrogen-fixing microbe; and/or
(g) a methanotrophic microbe.

In embodiments, the microbial composition comprises at least one microbe that increases the nutritive value and/or health value of the product composition, and/or reduces the environmental impact of the method which is selected from Bacillus subtilis, Lactobacillus plantarum, Lactobacillus acidophilus, Pediococcus pentosaceus, Aspergillus oryzae, Azotobacter vinelandii, Azospirillum sp., Bacillus megaterium (e.g. Bacillus megaterium var. phosphaticum), Bacillus polymyxa, Corynebacterium glutamicum, Aneurinbacillus danicus, Methylococcus capsulatus and Bacillus firmus.

As indicated above, the microbial composition thus may contain any types of microbe desired. The microbial composition may comprise prokaryotes and/or eukaryotes. Prokaryotes which may be included in the microbial composition include both bacteria and archaea. Both Gram-negative and/or Gram-positive bacteria may be included in the microbial composition. Eukaryotes which may be included in the microbial composition include in particular fungi. In a preferred embodiment the microbial composition comprises bacteria and fungi. That is to say, the microbial composition preferably comprises at least one species of bacteria and at least one species of fungus.

The microbes in the microbial composition may be obligate aerobes, facultative anaerobes or obligate anaerobes. Obligate aerobes and facultative anaerobes are preferred, as aerobic conditions are required for BSF larvae survival, but obligate anaerobes may be used if the microbial composition is mixed into the organic material prior to the incubation step, since the interior of the organic material may be anaerobic or have a low oxygen content.

In some embodiments the microbial composition does not comprise any pathogenic species. In other embodiments, however, the microbial composition does comprise pathogenic species. As set out below, the method may comprise a sterilisation step (e.g. using heat) and so the inclusion of pathogenic species in the composition may be acceptable, even if the method is for the purpose of producing an animal feed, so long as they are killed in the sterilisation process. However, if a pathogenic species is included in the microbial composition, it is preferred that the species does not produce exotoxins which survive the sterilisation process and are thus present and active in the product composition. For instance, if a heat sterilisation process is used, it is preferred that the microbial composition does not comprise a microbial species which produces a heat-stable exotoxin.

Similarly, endospores produced by bacteria in the microbial composition may survive any sterilisation process. Therefore in some embodiments it may be preferable if the microbial composition does not contain any spore-forming (i.e. endospore-forming) bacteria. In other embodiments however, the inclusion of spore-forming bacterial species is preferred (particularly of probiotic bacteria such as B. subtilis). It is however particularly preferred that no pathogenic spore-forming bacteria are included in the microbial composition.

The microbial species used in the microbial composition may be naturally-occurring (i.e. wild type) strains of the species in question (e.g. the species mentioned above), or, as indicated, genetically modified strains thereof. The composition may comprise a single strain of each species therein, multiple strains of each species therein, or single strains of some species therein and multiple strains of other species therein. Microbial species to be included in the microbial composition may be obtained from any source, e.g. culture banks such as the ATCC, as set out above.

In some embodiments, the microbial composition comprises at least 2, 3, 4, 5, 6, 7, 8, 9, 10, 11, 12, 13, 14, 15, 16, 17 or 18 different microbial species. For instance, the microbial composition may comprise at least 1, 2, 3, 4, 5, 6, 7, 8, 9, 10, 11, 12 or 13 of the following species: Bacillus licheniformis, Enterococcus faecium, Eubacterium ruminantium, Bacillus megaterium (e.g. Bacillus megaterium var. phosphaticum), Bacillus polymyxa, Streptomyces thermophilus, Bacillus subtilis, Saccharomyces cerevisiae, Aspergillus oryzae, Lactobacillus plantarum, Lactobacillus acidophilus, Pediococcus pentosaceus, Azotobacter vinelandii and Azospirillum sp. Preferably the microbial composition comprises at least 7, 10 or 12 of these species. In some embodiments the microbial composition comprises all 14 of these species, i.e. the microbial composition may comprise Bacillus licheniformis, Enterococcus faecium, Eubacterium ruminantium, Bacillus megaterium var. phosphaticum, Bacillus polymyxa, Streptomyces thermophilus, Bacillus subtilis, Saccharomyces cerevisiae, Aspergillus oryzae, Lactobacillus plantarum, Lactobacillus acidophilus, Pediococcus pentosaceus, Azotobacter vinelandii and Azospirillum sp.

The microbial composition may comprise at least 1, 2 or 3 species selected from Corynebacterium glutamicum, Aneurinbacillus danicus, Methylococcus capsulatus and Bacillus firmus. In some embodiments the microbial composition comprises all 4 of these species.

In some embodiments the microbial composition comprises:
(a) at least one species selected from Bacillus licheniformis, Enterococcus faecium, Eubacterium ruminantium, Bacillus megaterium var. phosphaticum, Bacillus polymyxa, Streptomyces thermophilus, Bacillus subtilis, Saccharomyces cerevisiae, Aspergillus oryzae, Lactobacillus plantarum, Lactobacillus acidophilus, Pediococcus pentosaceus, Azotobacter vinelandii and Azospirillum sp.; and
(b) at least one species selected from Corynebacterium glutamicum, Aneurinbacillus danicus, Methylococcus capsulatus and Bacillus firmus.

In some embodiments the composition comprises at least 2, 3, 4, 5, 6, 7, 8, 9, 10, 11, 12 or 13, or all of the species listed in (a) and at least 2 or 3, or all of the species listed in (b). In some embodiments the composition comprises the following species: Bacillus licheniformis, Enterococcus faecium, Eubacterium ruminantium, Bacillus megaterium var. phosphaticum, Bacillus polymyxa, Streptomyces thermophilus, Bacillus subtilis, Saccharomyces cerevisiae, Aspergillus oryzae, Lactobacillus plantarum, Lactobacillus acidophilus, Pediococcus pentosaceus, Azotobacter vinelandii, Azospirillum sp., Corynebacterium glutamicum, Aneurinbacillus danicus, Methylococcus capsulatus and Bacillus firmus.

Any suitable amount of the microbial composition may be applied to the organic material, as determined by the skilled person. For instance, the microbial composition may be applied to the organic material in a total amount in the range 1-10 g microbial composition/kg organic material, e.g. 1-9, 1-8, 1-7, 1-6, 1-5, 1-4, 1-3, 1-2, 2-10, 2-9, 2-8, 2-7, 2-6, 2-5, 2-4, 2-3, 3-10, 3-9, 3-8, 3-7, 3-6, 3-5, 3-4, 4-10, 4-9, 4-8, 4-7, 4-6, 4-5, 5-10, 5-9, 5-8, 5-7, 5-6, 6-10, 6-9, 6-8, 6-7, 7-10, 7-9, 7-8, 8-10, 8-9 or 9-10 g microbial composition/kg organic material. In preferred embodiments 3-7 or 4-6 g microbial composition/kg organic material is used, e.g. about 3, 3.5, 4, 4.5, 5, 5.5, or 6 g microbial composition/kg organic material.

The microbial composition may be applied to the organic material in a total amount in the range about 5×10⁹ to 5×10¹¹ cfu/kg organic material. For instance, about 5×10⁹, 6×10⁹, 7×10⁹, 8×10⁹, 9×10⁹, 10¹⁰, 2×10¹⁰, 3×10¹⁰, 4×10¹⁰, 5×10¹⁰, 6×10¹⁰, 7×10¹⁰, 8×10¹⁰, 9×10¹⁰ or 10¹¹ cfu/kg, to 5×10¹¹, 4×10¹¹, 3×10¹¹, 2×10¹¹, 10¹¹, 9×10¹⁰, 8×10¹⁰, 7×10¹⁰, 6×10¹⁰, 5×10¹⁰, 4×10¹⁰, 3×10¹⁰, 2×10¹⁰ or 10¹⁰ cfu/kg. For example, the microbial composition may be applied to the organic material in a total amount in the range about 5×10⁹ to 10¹⁰ cfu/kg, 10¹⁰ to 5×10¹⁰ cfu/kg, 5×10¹⁰ to 10¹¹ cfu/kg, 10¹¹ to 5×10¹¹ cfu/kg or 10¹⁰ to 10¹¹ cfu/kg.

Each microbial species present in the microbial composition may be present in the microbial composition in any suitable amount such that a sufficient amount of the microbe is applied to the organic material to be effective in its processing. Each species in the microbial composition may be present in the same amount, or each may be present in different amounts, or different groups of species may be present in different amounts.

For example, a microbial species may be present in the microbial composition in an amount from about 10⁸ to 10¹⁰ cfu/kg organic material, e.g. from about 10⁸, 2×10⁸, 3×10⁸, 4×10⁸, 5×10⁸, 6×10⁸, 7×10⁸, 8×10⁸, 9×10⁸, 10⁹, 2×10⁹, 3×10⁹ 4×10⁹ or 5×10⁹ cfu/kg organic material to about 10¹⁰, 9×10⁹, 8×10⁹, 7×10⁹, 6×10⁹, 5×10⁹, 4×10⁹, 3×10⁹, 2×10⁹, 10⁹, 9×10⁸, 8×10⁸, 7×10⁸, 6×10⁸ or 5×10⁸ cfu/kg organic material. For instance, a microbial species may be present in the microbial composition in an amount from about 10⁸ to 10⁹ cfu/kg, 5×10⁸ to 10⁹ cfu/kg, 5×10⁸ to 5×10⁹ cfu/kg, 10⁹ to 5×10⁹ cfu/kg, 10⁹ to 10¹⁰ cfu/kg or 5×10⁹ to 10¹⁰ cfu/kg. For instance, a microbial species may be present in the microbial composition in an amount of about 10⁸, 5×10⁸, 10⁹, 2×10⁹, 3×10⁹, 4×10⁹, 5×10⁹, 6×10⁹, 7×10⁹, 8×10⁹, 9×10⁹ or 10¹⁰ cfu/kg organic waste. Optimal amounts of each microbial species in the microbial composition may be readily determined by the skilled person based on e.g. the combination of species used in the composition and the organic material to which the microbial composition is to be applied.

By cfu is meant ‘colony-forming unit’ as is standard in the art.

Once the organic material has been contacted with the BSF larvae and the microbial composition, it is incubated. That is to say, the organic substrate is incubated with the BSF larvae and the microbial composition.

During the incubation step, the organic substrate is processed by both the BSF larvae and the microbial composition. The processing of the organic substrate by the microbial composition as referred to herein as fermentation of the organic substrate.

The incubation step may be performed under ambient conditions (e.g. at environmental temperature and humidity) or under controlled conditions. The organic material may be incubated at a temperature of about 20-35° C., e.g. 25-35° C., 26-34° C., 27-33° C., 28-32° C., 29-31° C., 25-30° C., 26-30° C., 27-30° C., 28-30° C., 29-30° C., 25-29° C., 25-28° C., 25-27° C., 26-29° C., 26-28° C., 26-27° C., 27-29° C., 27-28° C. or 28-29° C. Preferably the organic material is incubated at 28-30° C., e.g. 28-29° C., 29-30° C., about 28° C., about 29° C. or about 30° C.

The relative humidity for the incubation is preferably in the range 60-100%, e.g. 70-100, 80-100, 90-100, 60-90, 60-80, 60-70, 70-100, 70-90, 70-80, 75-85, 80-100, 80-90 or 90-100%. A preferred range for relative humidity is 75-85%, e.g. about 80%.

Preferably, the organic material is incubated at about 28-30° C. and a relative humidity of about 75-80%.

The incubation is performed under aerobic conditions, since BSF larvae are aerobic organisms. The incubation may be performed in atmospheric air. The incubation may be performed under air flow, e.g. at a rate of about 2000-12000 cfm, such as 3000-11000, 4000-10000, 5000-9000 or 6000-8000 cfm.

Advantageously, by fermenting the organic material at the same time as it is processed by BSF larvae, aerobic conditions can be provided without use of any mechanical aerator, e.g. a stirrer or suchlike. The BSF larvae act as aerators instead. Thus in an embodiment the method comprises fermenting the organic material under aerobic conditions without use of a mechanical aerator. Alternatively, the method may be seen to comprise fermenting the organic material under aerobic conditions without use of an inanimate (i.e. non-living) aerator.

The incubation step may be performed for any suitable length of time, as determined by the skilled person. Suitable lengths of time for the incubation step are set out above (see the discussion regarding the length of the degradation process).

In some embodiments, the incubation step comprises parallel fermentation of two layers of organic material. In such embodiments, two layers of organic material may be separately prepared for processing/fermentation by addition of BSF larvae and/or a microbial composition, as described above. The second layer of the material can then be placed upon the first layer, such that the second layer is directly upon the first layer, and the incubation step then performed. Alternatively, a first layer of organic material may be prepared for processing/fermentation, and a second layer of organic material placed on top of the first layer, and the second layer then prepared for processing/fermentation in situ. In this case, the upper second layer is not mixed with the lower first layer.

In some embodiments, both the first and second layer contain BSF larvae. In preferred embodiments, only the first (lower) layer contains BSF larvae. Generally, both the first and second layers comprise a microbial composition for fermentation.

Where a two layer fermentation step is performed, the organic material forming the first layer may be the same as or different to the organic material forming the second layer. Preferably, the first and second layers are formed of different organic materials. In this case, the first and second layers may be of approximately the same density, or the second (upper) layer may be of lower density than the first layer.

Similarly, the same microbial composition may be used to ferment the organic material in both layers, or different microbial compositions may be used for each layer. In a particular embodiment, the first layer is fermented with any microbial composition as discussed above, and the second (upper) layer is fermented with a microbial composition comprising Aspergillus oryzae. A. oryzae has been found to thrive particularly in okara (soy pulp), which may be used as the upper layer in some embodiments.

Using a two-layer fermentation process has been found to improve performance of the BSF larvae. Processing of the two layers by BSF larvae during the incubation step generally results in homogenisation of the two layers, resulting in the production of a single homogenous product.

In some embodiments, a cooling pad is used during the incubation step. The cooling pad consists of or comprises a heat-absorbing material. The cooling pad may be placed adjacent to (e.g. against or in the vicinity of) the fermenting material (e.g. in the same room or building as the fermentation is performed) to prevent the fermenting material overheating or to cool the fermentation area. In a particular embodiment, the heat-absorbing material is water.

The cooling pad may in particular be an evaporative cooling pad using one or more sheets of a cellulose-based material, such as cardboard or paper (e.g. kraft paper). Such a cooling pad may commonly comprise corrugated sheets which may be attached to each other using e.g. glue. The sheets may be treated with resins or other agents to provide water resistance, prevent rot and/or improve the durability or lifespan of the cardboard. Such cooling pads function by running water down the cellulose-based sheets. The water removes heat from the air and is evaporated. Evaporative cooling sheets of this type are readily commercially available.

The cooling pad may comprise a water-proof holder (e.g. a metal holder) surrounding the sheets of cellulose-based material. Windows in the holder provide access from the cellulose-based sheets to the environment. The cooling pad may comprise a sump at the base for collection of water which has run down the cellulose-based sheets, and a pump to pump the water back up to the top of the pad to be reused. The water may be replaced and/or topped-up at regular intervals.

Fermentation may result in the production of foul-smelling or toxic gases, in particular ammonia, which can dissolve in the water of the cooling pad, removing them from the environment. This can avoid build up of gases which might otherwise have a negative effect on the BSF larvae and microorganisms used for the fermentation, and also improve the odour of the fermentation process.

Thus the fermentation step may be performed using an evaporative cooling pad to remove heat and or gaseous by-products of the fermentation process from the environment.

Unexpectedly, use of a cooling pad in this manner can cause the processing of the organic material to become a carbon-neutral, or even carbon-negative process. Without being bound by theory, it may be that alkalisation of water in the cooling pad by dissolution of ammonia therein increases the solubility of CO₂ in the water, resulting in excess CO₂ being taken up in the water from the environment.

The processing of the organic material, including the fermentation by the microorganisms and consumption by the BSF larvae, yields a product composition. The product composition comprises fermented organic material, BSF larvae biomass and microbial biomass, as discussed above. The product composition may be an animal feed composition, as discussed above. The product composition generally further comprises frass (from the BSF larvae), particularly fermented frass (i.e. fermented BSF frass), as also discussed above. The product composition may also comprise the nutrients, postbiotics and suchlike which are produced by the microbial composition, as discussed above, such as amino acids, vitamins, antioxidants and/or antimicrobial compounds.

At the end of the incubation process, the product composition may be further processed to improve its suitability for use as an animal feed, e.g. to improve its transportability or storage. The product composition may be blended (as discussed above in respect of the optional blending step before the fermentation step). Thus the method may comprise a further step of blending the product composition. Blending may also kill the BSF larvae.

In the method of the invention, generally only a single fermentation step is performed. Thus once the incubation step is complete, no further microbial composition is added. If a blending step is performed after the incubation step, no subsequent incubation or fermentation step is generally performed.

A preservative may be added to the product composition in order to increase its shelf life and prevent spoilage. Suitable preservatives are known in the art and discussed above. When the product composition is also being blended, the preservative may be added before or after the composition is blended.

The product composition may be subjected to a sterilisation step (i.e. the method may further comprise a sterilisation step). In the sterilisation step the product composition is treated to kill the living organisms within it, particularly the BSF larvae (if no blending step was performed, or if some larvae survived the process) and the microorganisms from the microbial composition. The sterilisation step kills all or essentially all living organisms within the product composition, though viable bacterial endospores may remain. The sterilisation step may kill all living organisms within the product composition and destroy (i.e. render non-viable) any bacterial endospores within the composition.

The sterilisation step may be implemented by any effective means known to the skilled person, but is preferably performed by heat-treating the product composition. If the product composition is also being blended, the blending step may be performed before, after or concurrently with the sterilisation step. Similarly, if a preservative is being added, this may be added before or after the sterilisation step.

If the product composition is heat treated a sufficiently high temperature is applied to the composition for a sufficient length of time to sterilise the composition. For instance, a temperature of at least about 50, 60, 70, 80, 90 or 100° C. may be applied for a period of at least 0.5, 1, 1.5, 2, 2.5 or 3 hours or more. In some embodiments, a temperature of about 75-85° C. (e.g. about 80° C.) is applied to the product composition for 1.5-2.5 hours (e.g. about 2 hours). In other embodiments, a temperature of 80-100° C., e.g. 80-90° C., 80-95° C., 85-100° C., 85-95° C. or 90-100° C. may be used.

When heat sterilisation is performed, the heating step can also act as a drying step, drying out and removing water content from the product composition. The product composition may have a low water content, as described above in respect of the animal feed composition of the invention.

In some embodiments, a two-step heating process is performed. In such embodiments, the first step is a pre-heating step, and the second step is a sterilisation/drying step as described above. The pre-heating step is performed at a lower temperature than the drying step, for example the pre-heating step may be performed at a temperature of about 50-70° C., e.g. 50-60° C., 50-65° C., 55-65° C. or 60-70° C. The pre-heating step may be performed for any suitable period of time, e.g. at least 0.5, 1, 1.5, 2, 2.5 or 3 hours or more. A drying step performed after a pre-heating step may be performed at a temperature of e.g. 80-100° C., e.g. 80-90° C., 80-95° C., 85-100° C., 85-95° C. or 90-100° C., as set out above.

The purpose of the pre-heating step is to stimulate sporulation of sporulating probiotic bacteria (e.g. B. subtilis, B. licheniformis, B. megaterium or B. polymyxa) to form endospores capable of surviving the higher temperatures used for the drying step. Thus the pre-heating step is performed at a temperature high enough to cause heat stress in such species in order to promote sporulation, but not so high that the bacteria are killed before sporulation is complete.

When a heat treatment step is performed, this may be at the end of the incubation step, or immediately after the blending step (where a blending step is performed). By “immediately after” is meant that no separate step is performed in between the blending and heating steps, in particular no additional fermentation step is performed between the blending and heating steps. Any gap between the blending and heating step is generally short, to enable procession between the steps, e.g. of less than 24, 12, 10, 8, 6, 4 or 2 hours.

Where RS2 starch is included in the organic material fermented by the microbial composition, a heat treatment step at the end of fermentation advantageously converts any remaining RS2 starch (which as set out above is particularly suitable for microbial fermentation) into RS3 starch (which as set out above is beneficial for animals) which is included in the product composition.

The product composition may be pelleted or pelletised (the terms are used interchangeably herein), i.e. turned into pellets. Pelleted animal feed is often preferred in farming as pelleted food is associated with higher quality, lower pathogen content, lower dust levels and greater ease of handling than powdered feeds. Feed pelleting processes are well known in the art, and commonly utilise steam injection to moisten and compress dry food into pellets.

The product composition may have a nutritional make-up (in terms of protein, carbohydrate and fat content) as described above in respect of the animal feed composition. The product composition may optionally be defatted. Defatting may be performed by any method known in the art. For instance, defatting may be achieved by screw press.

As shown in the examples, the method of the invention has a high product yield, in terms of yield of the product composition by its dry mass relative to the starting dry mass (i.e. the dry mass of the substrate organic material in combination with the BSF larvae/eggs and microbial composition applied to it). For instance, the method of the invention preferably yields a product composition with a dry mass of at least 75, 80, 85, 90 or 95% of the starting dry mass.

The method of the invention may comprise a further step of formulating the product composition into an animal feed. This formulating step may comprise mixing the product composition with one or more other ingredients. For instance, where the product composition is used as a supplement for another (e.g. existing) animal feed, this step comprises mixing the product composition with the other animal feed. The animal feed may be for (i.e. suitable for, and potentially designed for) any animal of interest. Generally the animal will be a farmed animal, as discussed above, e.g. a fish or crustacean as discussed above.

In a third aspect, the invention provides the use of BSF larvae and a microbial composition for degrading organic material, the use being as defined above in the method of the invention. The use thus yields a product composition as defined above.

In a fourth aspect, the invention provides a product composition which is obtainable (i.e. which may be obtained) from a method or use of the invention. Preferably, the product composition of the invention is obtained by a method or use of the invention as described above.

In a fifth aspect, the invention provides a composition for degrading organic material, the composition comprising a microbial composition as defined above and black soldier fly larvae or black soldier fly eggs. The composition may be used to degrade organic material as described above in the method of the invention. Thus the composition preferably comprises black soldier fly larvae or eggs and the microbial composition in an appropriate ratio for use in the method of the invention.

In a sixth aspect, the invention provides a kit for degrading organic material comprising black soldier fly larvae or black soldier fly eggs and a microbial composition as defined above. In the kit, the BSF larvae/eggs may be provided separated from the microbial composition (e.g. in separate packets or compartments) or combined with the microbial composition in a single mixture.

The present invention may be better understood by reference to the non-limiting examples and figures below:

### FIGURE LEGENDS

FIG. 1 shows the survival rate of farmed shrimp fed either a standard shrimp food diet (control) or an experimental diet comprising standard shrimp food plus 20% w/w of an animal feed composition of the invention.

FIG. 2 shows the relative survival rates of shrimp fed either a standard shrimp food diet (control) or an experimental diet comprising the standard shrimp food supplemented with 2% w/w of an animal feed composition of the invention (“Full Circle Product”). At each 35 day, the left-hand bar indicates the control survival rate and the right-hand bar the experimental survival rate. Error bars indicate standard deviation.

FIG. 3 shows the average weight increase of Pacific white shrimp after 45 days of feeding with either a control standard shrimp food diet or the standard shrimp food supplemented with 2% w/w of an animal feed composition of the invention (“Full Circle Product”). Error bars indicate standard deviation.

FIG. 4 shows representative Pacific white shrimp after 45 days of feeding with either a control standard shrimp food diet or the standard shrimp food supplemented with 2% w/w of an animal feed composition of the invention (“Full Circle Product”).

FIG. 5 shows the feed conversion ratios of Pacific white shrimp after 45 days of feeding with either a control standard shrimp food diet or the standard shrimp food supplemented with 2% w/w of an animal feed composition of the invention (“Full Circle Product”). Error bars indicate standard deviation.

### EXAMPLES

### Example 1—Yield Tests

The following organic samples (set out in Table 1) were used to determine the yield of dry product composition relative to the starting dry weight:

TABLE 1
Samples used for yield experiments

| | Substrate | Substrate Dry Matter |
|---|---|---|
| Sample No. | Type | (DM) Quantity (g) |
| 1 | Plant | 1250 |
| 2 | Plant | 44.5 |
| 3 | Plant | 44.5 |
| 4 | Plant | 44.5 |
| 5 | Plant | 44.5 |
| 6 | Plant | 44.5 |
| 7 | Plant | 44.5 |
| 8 | Plant | 1575 |
| 9 | Fish & Plant | 1188 |
| 10 | Plant | 1188 |
| 11 | Fish | 1575 |

BSF larvae were applied to the substrates with a microbial composition comprising a mixture of digestive microbes, protein-enhancing microbes, lactic acid bacteria and nitrogen-fixing bacteria. Substrates were then incubated for 6-12 days (as indicated in Table 2 below). The results are set out in Table 2, below:

TABLE 2
Yields of experimental organic waste degradations.

| | Test Duration | DM Yield | DM Yield |
|---|---|---|---|
| Sample | (days) | (g) | (%)¹ |
| 1 | 12 | 1163 | 93.04 |
| 2 | 10 | 36.3 | 81.57 |
| 3 | 10 | 30.6 | 68.76 |
| 4 | 10 | 29.1 | 65.39 |
| 5 | 10 | 39.2 | 88.09 |
| 6 | 10 | 34.8 | 78.2 |
| 7 | 10 | 48.4 | 108.76 |
| 8 | 10 | 1536 | 97.52 |
| 9 | 6 | 1260 | 106.06 |
| 10 | 6 | 1266 | 106.57 |
| 11 | 11 | 909 | 57.71 |

¹Dry mass yield as a percentage of original dry mass

The average dry mass yield of the experiments was 86.52%. This was considered an excellent yield.

### Example 2—Nutrition Content Tests

Degradation experiments were performed as in Example 1 above to investigate the nutritional content of animal feed compositions obtained by processing of Amygdalus, Salmonid, Elaeis (oil palm) and a mixture of 75% Colocasia esculenta (taro) and 25% pig blood. The results are presented in Table 3:

TABLE 3
Nutrient content of animal feed compositions obtained by processing of various substrates.

| | Pre-Processing Content | | | Post-Processing Content | | | Macronutrient Yield Relative | | |
|---|---|---|---|---|---|---|---|---|---|
| | on DM Basis (%) | | | on DM Basis (%) | | | to Original Substrate (%) | | |
| Substrate | Protein | Carb | Fat | Protein | Carb | Fat | Protein | Carb | Fat |
| Amygdalus | 25 | 56 | 12 | 28.9 | 36.4 | 24.3 | 116 | 65 | 203 |
| Elaeis | 17 | 58 | 10 | 16.2 | 51.5 | 11.7 | 95 | 89 | 117 |
| Salmonid | 60 | 0 | 34 | 55.9 | 8.3 | 31.3 | 93 | — | 92 |
| Esculenta/PB | 28 | 65 | 24 | 32.5 | 51.6 | 3.13 | 118 | 80 | 13 |

PB = pig blood.

As would be expected, different substrates had substantially different nutrient compositions and the starting nutrient compositions were reflected in the product nutrient compositions. In no cases was a significant reduction in protein content seen, and in some cases a significant increase in protein content was seen.

The products obtained from the Amygdalus, Elaeis and Salmonid substrates were defatted by screw press to leave a total fat content for each product of only 5%. For the Amygdalus products this gave a protein content of 32% and a carbohydrate content of 40.2% on a dry matter basis; for the Elaeis products this gave a protein content of 16.9% and a carbohydrate content of 55% on a dry matter basis; for the Salmonid products this gave a protein content of 75.9% and a carbohydrate content of 11.3% on a dry matter basis.

### Example 3—Feeding of Whiteleg Shrimp with Animal Feed Composition of Invention

An animal feed composition was produced by processing of palm decanter cake using BSF larvae and a microbial composition as used in Examples 1 and 2 above. The process was performed in Thailand, and following application of the BSF larvae and microbial composition to the palm decanter cake the substrate was incubated under ambient conditions for 10 days. At the end of the process, the mixture was blended and dried and sterilised by heating at 80° C. for 2 hours.

The resulting animal feed composition was added to CP basal shrimp feed (CP Prima, Indonesia) at an amount of 20% w/w. Shrimp were fed either CP basal shrimp feed alone or the feed supplemented with 20% of the composition of the invention, and their growth compared, as set out below:

### Shrimp Samples

58 naïve whiteleg shrimp of ~3 g fresh weight were obtained from a white shrimp farm in ChachoengSao province, Thailand. The shrimp were acclimatised for 2 days in rearing water at 10 ppt salinity and pH 8, before the start of the feeding trial.

### Feeding Trial

Shrimp (~190 g fresh weight in total) were divided into 2 tanks (0.6 m×0.45 m×0.8 m) containing 29 individuals each, and reared in 10 ppt artificial seawater (Marinium®, Thailand) with continuous aeration at 29-30° C. Water quality parameters such as pH, alkalinity and ammonia were measured every other day. Animals were fed 6% of their body weight using an automatic feeder set to release 4 portions every 24 h of each respective diet. The trial was carried out over a period of 24 days, during which mortalities were recorded in both groups.

### Results and Discussion

During the trial a number of shrimp deaths were recorded. A better survival rate was observed in the group fed with 20% animal feed composition of the invention added into the diet (FIG. 1 and Table 4), though this was not statistically significant. Water quality parameters such as pH, alkalinity and ammonia (NH3) were recorded using commercially available kits to ensure appropriate culture conditions, and the results indicated that the water quality parameters were of normal values.

The present results demonstrate at least that the animal feed composition of the invention is suitable to be fed to whiteleg shrimp (i.e. it is not toxic to them). It is possible that the animal feed composition enhances whiteleg shrimp survival, though to determine this a larger feeding trial is required.

TABLE 4
Survival of Whiteleg Shrimp. ‘Control survival’ indicates
survival of shrimp in the control group, fed CP basal shrimp
feed; ‘Experimental survival’ indicates survival of
shrimp in the experimental group fed CP basal shrimp feed
supplemented with the animal feed composition of the invention.

| Trial Day | 1 | 3 | 14 | 21 |
|---|---|---|---|---|
| Control Survival | 100% | 76.2% | 71.4% | 57.1% |
| Experimental Survival | 96.6% | 86.2% | 75.9% | 69% |

### Example 4—Large Scale Shrimp Growth Trial

The growth trial was performed at the Aquaculture Business Research Center (ABRC), Faculty of Fisheries, Kasetsart University, 50 Phaholyothin Rd., Chatuchak, Bangkok, 10900 Thailand.

### Methods

Specific pathogen-free white shrimp of size 2-4 g were used in this study. A total of 400 shrimp from a farm were transported to the Aquaculture Business Research Center laboratory, Faculty of Fisheries, Kasetsart University. Shrimp were acclimatised in fibreglass tanks for 14 days.

In the experiment, a total of 8 500-litre tanks were used for rearing shrimp with 25-30 ppt salt seawater. Shrimp were stocked at a density of 40 shrimp/tank. Two experimental groups with two replicates were studied as follows:
Diet 1: Control.
Diet 2: supplemented with feed composition of the invention 2% as a feed additive.

The compositions of the control and supplemented media are set out in Table 5, below.

Shrimp were fed four times daily with a specific shrimp feed at the satiation rate. The feeding rate was adjusted according to shrimp weight throughout the 45-day experimental period. Water quality parameters such as pH, dissolved oxygen (DO), alkalinity, ammonia and nitrite were maintained to optimal levels for rearing shrimp and analysed weekly throughout the experiment. The survival rate was recorded every 2 weeks. Shrimp were weighed at the end of the trial. The feed conversion ratio (FCR), the protein efficiency ratio (PER), and the feed efficiency ratio (FER) were determined at the end of the experiment. At the end of the experiment, all detailed data from all experimental groups were statistically compared using a t-test.

TABLE 5
Compositions of the control shrimp feed and the
shrimp feed supplemented with 2% product of
the invention (“Full Circle Product”).

| | | 2% Full Circle |
|---|---|---|
| Ingredient | Control | Product |
| Shrimp Shell Meal 45% | 5.00 | 4.90 |
| Fish Meal 65% CP | 8.80 | 8.62 |
| Mineral additive | 1.50 | 1.47 |
| Squid Meat Meal | 1.50 | 1.47 |
| Squid Viscera for Shrimp | 1.75 | 1.72 |
| Poultry Meal 64% | 12.00 | 11.76 |
| Soybean Meal High Protein | 21.50 | 21.07 |
| Fermented Soybean Meal | 5.00 | 4.90 |
| Corn Gluten | 3.50 | 3.43 |
| Wheat Gluten | 1.25 | 1.23 |
| Wheat Flour (Thailand) | 22.50 | 22.05 |
| Rice Bran | 5.00 | 4.90 |
| Shrimp Mineral Premix | 0.20 | 0.20 |
| Shrimp Vitamin Premix | 0.20 | 0.20 |
| Mono Calcium Phosphate (MCP) | 1.25 | 1.23 |
| Vitamin C 35% ( [symbol] ) | 0.30 | 0.29 |
| Choline Chloride 60% Powder | 0.30 | 0.29 |
| Salt | 1.00 | 0.98 |
| Vitamin E | 0.05 | 0.05 |
| Lysine | 0.03 | 0.03 |
| DL-Methionine | 0.05 | 0.05 |
| Binder | 0.20 | 0.20 |
| Total emulsifier | 0.20 | 0.20 |
| LYSO Lecithin | 0.15 | 0.15 |
| Antioxidant for shrimp liq | 0.03 | 0.03 |
| Fish oil for shrimp | 0.50 | 0.49 |
| Shrimp paste | 0.25 | 0.25 |
| Fish Soluble Extract | 1.50 | 1.47 |
| Lecithin | 2.50 | 2.45 |
| Fish hydrolysate | 2.20 | 2.16 |
| Full Circle Product | — | 2.00 |

Chemical composition by proximate analysis

| | | |
|---|---|---|
| Ash (%) | 12.56 | 12.56 |
| Fat (%) | 9.37 | 9.59 |
| Moisture (%) | 12.52 | 11.70 |
| Protein (% N × 6.25) | 39.96 | 39.97 |

### Results

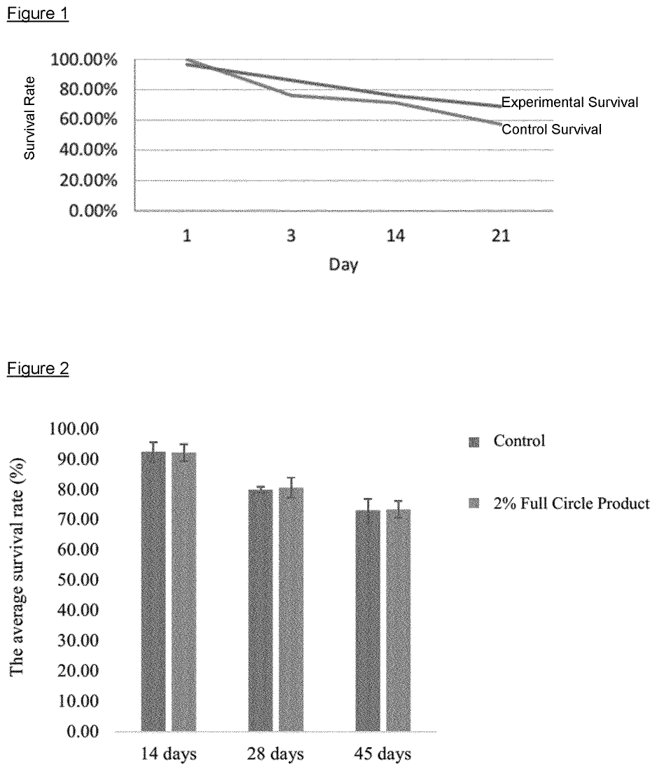

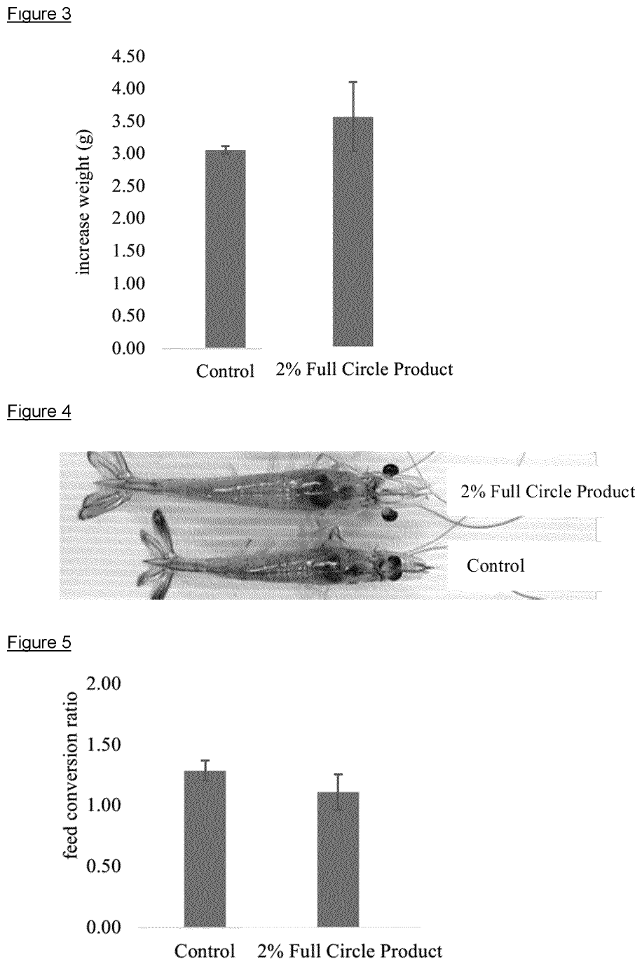

There was no difference in the survival rate of shrimp fed different diets throughout the study period (Table 6 and FIG. 2). The shrimp fed a diet supplemented with 2% feed additive of the invention had the most increased weight (Table 7 and FIGS. 3-4). There was a significantly higher increased weight of shrimp from this group than the control group. For the feed conversion ratio (FCR), Shrimp fed a diet supplemented with 2% feed additive of the invention had a significantly lower FCR than the control group, indicating greater efficiency of conversion of the supplemented feed into shrimp mass (Table 7 and FIG. 5). There was no difference in the FER and PER between the experimental and control groups (Table 7).

TABLE 6
the average survival rate of Pacific white shrimp at
14, 28 and 45 days of feeding with different diets.

| | 14-day survival | 28-day survival | 45 day-survival |
|---|---|---|---|
| Feed | rate | rate | rate |
| Control | 92.50% ± 3.23^{a} | 80.00% ± 1.02^{a} | 73.13% ± 3.89^{a} |
| +2% supplement | 92.19% ± 2.77^{a} | 80.63% ± 3.31^{a} | 73.44% ± 2.77^{a} |

Data are presented as mean ± standard deviation. Means in the same column with different superscripts are significantly different from each other (p < 0.05)

TABLE 7
the average increase in weight, feed conversion ratio (FCR), feed
efficiency ratio (FER) and protein efficiency ratio (PER) of Pacific
white shrimp after 45 days of feeding with different diets.

| | Weight | | | |
|---|---|---|---|---|
| | Increase | | | |
| Feed | (g) | FCR | FER | PER |
| Control | 3.06 ± 0.06^{a} | 1.29 ± 0.08^{a} | 77.78 ± 4.78^{a} | 1.95 ± 0.12^{a} |
| +2% | 3.57 ± 0.53^{b} | 1.11 ± 0.14^{b} | 91.14 ± 12.93^{a} | 2.28 ± 0.32^{a} |
| supplement | | | | |

Data are presented as mean ± standard deviation. Means in the same column with different superscript are significantly different from each other (p < 0.05).

1. A composition for animal feed comprising a fermented organic material, black soldier fly biomass, fermented black soldier fly frass and microbial biomass.

2. The composition of claim 1, wherein the composition comprises about 5 to 25% w/w black soldier fly biomass and about 0.05 to 5% w/w microbial biomass.

3. The composition of claim 1 or 2, wherein the composition is crushed, ground or blended, optionally wherein the composition is powdered.

4. The composition of any one of claims 1 to 3, wherein the composition has a water content of 10% (v/v) or less.

5. The composition of any one of claims 1 to 4, wherein the black soldier fly biomass comprises dead black soldier fly larvae.

6. The composition of any one of claims 1 to 5, wherein the composition is free of living organisms, optionally wherein the composition is sterile.

7. The composition of any one of claims 1 to 6, wherein the microbial biomass comprises bacterial biomass and fungal biomass.

8. The composition of any one of claims 1 to 7, wherein the microbial biomass comprises:
(i) at least one microbe selected from Bacillus licheniformis, Enterococcus faecium, Eubacterium ruminantium, Bacillus megaterium var. phosphaticum, Bacillus polymyxa and Streptomyces thermophilus;
(ii) at least one microbe selected from Bacillus subtilis, Saccharomyces cerevisiae, Aspergillus oryzae and Streptomyces thermophilus; and
(iii) at least one microbe selected from Bacillus subtilis, Lactobacillus plantarum, Lactobacillus acidophilus, Pediococcus pentosaceus, Aspergillus oryzae, Azotobacter vinelandii, Azospirillum sp., Bacillus megaterium var. phosphaticum and Bacillus polymyxa.

9. The composition of claim 8, further comprising at least one of Corynebacterium glutamicum, Aneurinbacillus danicus, Methylococcus capsulatus and Bacillus firmus.

10. The composition of claim 8 or 9, comprising Bacillus subtilis.

11. The composition of any one of claims 8 to 10, wherein the microbial biomass comprises at least 4 microbial species selected from Bacillus licheniformis, Enterococcus faecium, Eubacterium ruminantium, Bacillus megaterium var. phosphaticum, Bacillus polymyxa, Streptomyces thermophilus, Bacillus subtilis, Saccharomyces cerevisiae, Aspergillus oryzae, Lactobacillus plantarum, Lactobacillus acidophilus, Pediococcus pentosaceus, Azotobacter vinelandii and Azospirillum sp.,
preferably wherein the microbial biomass comprises at least 7, at least 10 or at least 12 of the said microbial species, or all of the said microbial species.

12. The composition of claim 11, further comprising at least 2, at least 3, or preferably all of, Corynebacterium glutamicum, Aneurinbacillus danicus, Methylococcus capsulatus and Bacillus firmus.

13. The composition of any one of claims 1 to 12, wherein the composition comprises endospores of one or more sporulating species of bacteria, preferably B. subtilis spores.

14. The composition of any one of claims 1 to 13, wherein the composition comprises resistant starch type 3 (RS3 starch).

15. The composition of any one of claims 1 to 14, wherein the fermented organic material is a fermented food waste product.

16. The composition of any one of claims 1 to 13, wherein the composition further comprises a preservative and/or is pelletised.

17. A method for degrading organic material, the method comprising contacting the organic material with black soldier fly larvae and a microbial composition comprising at least one microbe capable of fermenting the organic material, and incubating the organic material with the black soldier fly larvae and the microbial composition;
wherein the method yields a product composition comprising fermented organic material, black soldier fly larvae biomass and microbial biomass.

18. The method of claim 17, wherein the microbial composition comprises:
(i) at least one digestive microbe, wherein the digestive microbe secretes a digestive enzyme;
(ii) at least one protein-enhancing microbe, wherein the protein-enhancing microbe increases the protein content of the product composition; and
(iii) at least one microbe that increases the nutritive value and/or health value of the product composition, and/or reduces the environmental impact of the method.

19. The method of claim 17 or 18, wherein the organic material is food waste.

20. The method of any one of claims 17 to 19, comprising grinding, crushing and/or blending the organic material prior to application of the black soldier fly larvae and microbial composition.

21. The method of any one of claims 17 to 20, wherein the product composition is an animal feed or animal feed component.

22. The method of any one of claims 17 to 21, wherein the microbial composition comprises at least one bacterial species and at least one fungal species.

23. The method of any one of claims 18 to 22, wherein a protease and a carbohydrase are secreted by the at least one digestive microbe.

24. The method of claim 23, wherein a cellulase, a xylanase and/or an amylase are secreted by the at least one digestive microbe.

25. The method of any one of claims 18 to 24, wherein the at least one microbe of (iii):
(a) degrades toxins;
(b) secretes an antimicrobial compound;
(c) is a lactic acid-producing microbe;
(d) produces an antioxidant and/or a vitamin;
(e) secretes an amino acid, preferably lysine and/or glutamate;
(f) is a nitrogen-fixing microbe; and/or
(g) is a methanotrophic microbe.

26. The method of any one of claims 18 to 25, wherein the at least one digestive microbe is selected from Bacillus licheniformis, Enterococcus faecium, Eubacterium ruminantium, Bacillus megaterium var. phosphaticum, Bacillus polymyxa and Streptomyces thermophilus.

27. The method of any one of claims 18 to 26, wherein the at least one protein-enhancing microbe is selected from Bacillus subtilis, Saccharomyces cerevisiae, Aspergillus oryzae and Streptomyces thermophilus.

28. The method of any one of claims 18 to 27, wherein the at least one microbe of (iii) is selected from Bacillus subtilis, Lactobacillus plantarum, Lactobacillus acidophilus, Pediococcus pentosaceus, Aspergillus oryzae, Azotobacter vinelandii, Azospirillum sp., Bacillus megaterium var. phosphaticum, Bacillus polymyxa, Corynebacterium glutamicum, Aneurinbacillus danicus, Methylococcus capsulatus and Bacillus firmus.

29. The method of any one of claims 17 to 28, wherein the microbial composition comprises at least 4 microbial species, preferably at least 7, at least 10, at least 14 or at least 18 microbial species.

30. The method of claim 29, wherein the microbial composition comprises Bacillus licheniformis, Enterococcus faecium, Eubacterium ruminantium, Bacillus megaterium var. phosphaticum, Bacillus polymyxa, Streptomyces thermophilus, Bacillus subtilis, Saccharomyces cerevisiae, Aspergillus oryzae, Lactobacillus plantarum, Lactobacillus acidophilus, Pediococcus pentosaceus, Azotobacter vinelandii and Azospirillum sp.

31. The method of claim 30, wherein the microbial composition further comprises Corynebacterium glutamicum, Aneurinbacillus danicus, Methylococcus capsulatus and Bacillus firmus.

32. The method of any one of claims 17 to 31, wherein the product composition further comprises frass, preferably fermented frass.

33. The method of any one of claims 17 to 32, wherein the organic material is incubated with the black soldier fly larvae and microbial composition for about 5 to 14 days.

34. The method of any one of claims 17 to 33, comprising:
(i) contacting a first layer of organic material with black soldier fly larvae and a first microbial composition comprising at least one microbe capable of fermenting the organic material;
(ii) contacting a second layer of organic material with a second microbial composition comprising at least one microbe capable of fermenting the organic material; and
(iii) incubating the organic material with the black soldier fly larvae and the microbial compositions,
wherein the second layer of organic material is on top of the first layer of organic material.

35. The method of claim 34, wherein the first and second layers of organic material are different.

36. The method of claim 34 or 35, wherein the second microbial composition comprises Aspergillus oryzae.

37. The method of any one of claims 17 to 36, wherein a cooling pad comprising water is used during the incubation.

38. The method of claim 37, wherein the cooling pad is an evaporative cooling pad comprising at least one sheet of a cellulose-based material.

39. The method of any one of claims 17 to 38, further comprising:
(i) grinding, crushing and/or blending the product composition;
(ii) adding a preservative to the product composition; and/or
(iii) pelletising the product composition.

40. The method of any one of claims 17 to 39, further comprising a sterilisation step.

41. The method of claim 40, wherein the sterilisation step is a heating step, the heating step comprising:
(i) pre-heating the product composition at a first temperature, wherein the first temperature stimulates sporulation of sporulating bacteria in the microbial composition; and
(ii) heating the product composition at a second temperature, wherein the second temperature is higher than the first temperature and renders the product composition free of living organisms,
wherein after the heating step the product composition comprises viable bacterial endospores.

42. The method of any one of claims 17 to 41, wherein the yield of dry mass in the product composition relative to the starting dry mass is at least 75%, preferably at least 80%, 85% or 90%.

43. The method of any one of claims 17 to 42, further comprising formulating the product composition into an animal feed, optionally comprising mixing the product composition with one or more other ingredients;
optionally wherein the animal feed is for a fish or crustacean.

44. Use of black soldier fly larvae and a microbial composition as defined in any one of claims 17 to 31 for degrading organic material, thereby to yield a product composition, optionally wherein the use, organic material and/or product composition are as defined in any one of claims 19 to 21 or 32 to 42.

45. A product composition obtainable from a method as defined in any one of claims 17 to 44.
